(19) United States
(12) Patent Application Publication
(10) Pub. No.: US 2015/0050941 A1
(43) Pub. Date: Feb. 19, 2015

(54) WIRELESS COMMUNICATION SYSTEM, COMMUNICATION METHOD, BASE STATION, AND COMMUNICATION TERMINAL

(71) Applicant: Sharp Kabushiki Kaisha, Osaka-shi, Osaka (JP)

(72) Inventors: Shinichi Sawada, Osaka-shi (JP); Tadashi Shimonabe, Osaka-shi (JP); Shigeto Suzuki, Osaka-shi (JP); Kouki Suzuki, Osaka-shi (JP); Mitsuru Sakamoto, Osaka-shi (JP); Yuhsuke Takagi, Osaka-shi (JP); Shumpei Fuse, Osaka-shi (JP); Akio Yoshihara, Osaka-shi (JP)

(21) Appl. No.: 14/381,672

(22) PCT Filed: Feb. 15, 2013
(86) PCT No.: PCT/JP2013/053632

§ 371 Date: Aug. 28, 2014

(30) Foreign Application Priority Data
Mar. 12, 2012 (JP) 2012-054744

(51) Int. Cl. H04W 72/04; H04W 72/08

(52) U.S. Cl. CPC H04W 72/0453; H04W 72/085; H04W 88/10
USPC 455/452.2; 455/452.1; 455/552.1

(57) ABSTRACT

A wireless communication system, a communication method, a base station, and a communication terminal are provided. The wireless communication system includes a base station, and a communication terminal that can communicate with the base station through a plurality of frequency bands. The wireless communication system includes a first notification module provided at one of the base station and communication terminal for notifying the other of the base station and communication terminal of a switching preparation request when a state is detected in which the frequency band used as the main frequency band among the plurality of frequency bands is to be switched, and a second notification module that notifies one of the base station and communication terminal of frequency band switching preparation completion in response to a determination of being in a state in which the frequency band used as the main frequency band is to be switched.

### TECHNICAL FIELD

The present invention relates to a wireless communication system including a communication terminal and a base station, a communication method of the wireless communication system, and a base station and a communication terminal directed to the wireless communication system. Particularly, the present invention relates to a configuration in which communication is established between a base station and a communication terminal through a plurality of frequency bands.

### BACKGROUND ART

3GPP (Third Generation Partnership Project) is now turning to the specification of LTE-A (LTE-Advanced) that is an advanced scheme of LTE (Long Term Evolution).

In LTE-A, communication of higher speed and higher capacitance than LTE is required to be implemented. Therefore, LTE-A has to support a frequency range of a broader band than LTE. According to the state of art, the maximum transmission bandwidth of LTE that is now 20 MHz will be expanded as wide as 100 MHz.

In view of the foregoing, LTE-A employs a wireless communication technique called carrier aggregation (CA) for the purpose of maintaining compatibility with LTE as much as possible. The carrier aggregation technique utilizes a frequency band with a bandwidth called component carrier (CC) up to 20 MHz. A plurality of such component carriers are used together to achieve a bandwidth as wide as 100 MHz at most. Thus, communication of high speed and high capacitance is realized.

At LTE and LTE-A, introducing a home evolved node B (hereinafter, also referred to as “HeNB base station”), in addition to the general evolved node B, hereinafter also referred to as “eNB base station”), is now being considered. This HeNB base station is directed to enlarging the service area and is for individual use or the like.

In general, a HeNB base station is envisaged to provide a service area smaller than the service area provided by an eNB base station. Hereinafter, a cell provided by an eNB base station is referred to as a “macrocell”, whereas a cell provided by a HeNB base station is referred to as a “home cell”.

### CITATION LIST

### Non-Patent Document

Non-Patent Document 1: Nokia Siemens Networks, Nokia Corporation, Alcatel-Lucent, “New work item proposal for Hetnet Mobility Improvements for LTE”, 3GPP TSG-RAN Meeting #51, RP-110438, Mar. 15-18, 2011.
Non-Patent Document 2: 3GPP Organization Partners “3rd Generation Partnership Project; Technical Specification Group Radio Access Network; Evolved Universal Terrestrial Radio Access (E-UTRA) and Evolved Universal Terrestrial Radio Access Network (E-UTRAN); Overall description; Stage 2 (Release 11)”, 3GPP TS 36, 300 V11.0.0 (2011-12).

### SUMMARY OF INVENTION

### Technical Problem

The approach that has been studied to date is directed to carrier aggregation between a communication terminal and a macrocell base station (eNB base station). The study of carrier aggregation between a communication terminal and a home cell base station (HeNB base station) has just started (Non-Patent Document 1).

Therefore, no specific proposal has been made as to how carrier aggregation is to be controlled between a communication terminal and a home cell base station, when carrier aggregation is to be performed between a communication terminal and a home cell base station (HeNB base station). This has become one issue of consideration.

An object of the present invention is to provide a wireless communication system, a communication method, a base station, and a communication terminal, allowing the frequency band to be used switched by more simplified procedures.

### Solution to Problem

A wireless communication system according to an aspect of the present invention includes a base station, and a communication terminal that can communicate with the base station through a plurality of frequency bands. The plurality of frequency bands include a main frequency band and at least one sub frequency band. The wireless communication system includes first notification means, provided at one of the base station and communication terminal, for notifying the other of the base station and communication terminal of a switching preparation request when a state is detected in which a frequency band used as the main frequency band among the plurality of frequency bands is to be switched; determination means, provided at the other of the base station and communication terminal, for determining, in response to the switching preparation request, whether in a state in which the frequency band used as the main frequency band is to be switched; second notification means for notifying the one of the base station and communication terminal of frequency band switching preparation completion in response to a determination of being in a state in which the frequency band used as the main frequency band is to be switched; and switching means for initiating, in response to the switching preparation completion, a switching process of the frequency band used as the main frequency band between the base station and communication terminal.

Preferably, the first notification means includes means for determining a communication quality of the frequency band used as the main frequency band.

Preferably, the first notification means includes means for determining whether a resource for the frequency band used as the main frequency band is insufficient or not.

Preferably, the plurality of frequency bands each have a service type defined. The first notification means includes means for determining whether in a state in which the frequency band used as the main frequency band is to be switched based on the service type of the frequency band used as the main frequency band.

Preferably, the plurality of frequency bands include a plurality of sub frequency bands. The first notification means includes means for notifying the switching preparation request including information indicating a sub frequency band that is a subject of switching.

Preferably, the first notification means is provided at the base station, and the determination means and second notification means are provided at the communication terminal.

Further preferably, the first notification means includes means for notifying together at one time a plurality of communication terminals connected to the base station of the switching preparation request. The determination means includes means for notifying that a frequency band switching process is not performed if not a subject of the switching preparation request.

Preferably, the first notification means is provided at the communication terminal, and the determination means and the second notification means are provided at the base station.

Preferably, the switching means includes means for notifying, after completing switching of the frequency band at the one of the base station and communication terminal, the other of the base station and communication terminal of a switching request instructing switching of the frequency band through the frequency band used as the new main frequency band.

According to another aspect of the present invention, there is provided a communication method between a base station and a communication terminal that can communicate with the base station through a plurality of frequency bands. The plurality of frequency bands include a main frequency band and at least one sub frequency band. The communication method includes the steps of: notifying, when a state is detected in which a frequency band used as the main frequency band among the plurality of frequency bands is to be switched, at one of the base station and communication terminal, the other of the base station and communication terminal of a switching preparation request; determining, in response to the switching preparation request at the other of the base station and communication terminal, whether in a state in which the frequency band used as the main frequency band is to be switched; notifying the one of the base station and communication terminal of frequency band switching preparation completion in response to a determination of being in a state in which the frequency band used as the main frequency band is to be switched; and initiating a switching process of the frequency band used as the main frequency band between the base station and communication terminal in response to the switching preparation completion.

According to still another aspect of the present invention, there is provided a base station that can communicate with a communication terminal through a plurality of frequency bands. The plurality of frequency bands include a main frequency band and at least one sub frequency band. The base station includes notification means for notifying the communication terminal of a switching preparation request when a state is detected in which a frequency band used as the main frequency band among the plurality of frequency bands is to be switched; and switching means for initiating a switching process of a frequency band used as the main frequency band between the base station and communication terminal in response to frequency band switching preparation completion from the communication terminal.

According to still another aspect of the present invention, there is provided a base station that can communicate with a communication terminal through a plurality of frequency bands. The plurality of frequency bands include a main frequency band and at least one sub frequency band. The base station includes determination means for determining, in response to a switching preparation request from the communication terminal, whether in a state in which the frequency band used as the main frequency band is to be switched; and notification means for notifying the communication terminal of frequency band switching preparation completion in response to a determination of being in a state in which the frequency band used as the main frequency band is to be switched.

According to still another aspect of the present invention, there is provided a communication terminal that can communicate with a base station through a plurality of frequency bands. The plurality of frequency bands include a main frequency band and at least one sub frequency band. The communication terminal includes notification means for notifying the base station of a switching preparation request when a state is detected in which a frequency band used as the main frequency band among the plurality of frequency bands is to be switched; and switching means for initiating, in response to frequency band switching preparation completion from the base station, a switching process of the frequency band used as the main frequency band between the base station and communication terminal.

According to still another aspect of the present invention, there is provided a communication terminal that can communicate with a base station through a plurality of frequency bands. The plurality of frequency bands include a main frequency band and at least one sub frequency band. The communication terminal includes determination means for determining, in response to the switching preparation request from the base station, whether in a state in which the frequency band used as the main frequency band is to be switched; and notification means for notifying the base station of frequency band switching preparation completion in response to a determination of being in a state in which the frequency band used as the main frequency band is to be switched.

### Advantageous Effects of Invention

According to the present invention, a frequency band to be used can be switched by further simplified procedures.

### BRIEF DESCRIPTION OF DRAWINGS

FIG. 1 schematically represents an entire configuration of a wireless communication system envisaged in an embodiment.

FIG. 2 is a schematic diagram to describe a component carrier (PCC/SCC) switching procedure at the wireless communication system shown in FIG. 1.

FIG. 3 is a block diagram representing a hardware configuration of a communication terminal used in the wireless communication system shown in FIG. 1.

FIG. 4 is a block diagram representing a hardware configuration of a HeNB base station used in the wireless communication system shown in FIG. 1.

FIG. 5 is a sequence chart representing the overall processing of PCC/SCC switching at the wireless communication system according to a first embodiment.

FIG. 6 is a flowchart of processing procedures involved in PCC/SCC switching at a HeNB base station in the wireless communication system according to the first embodiment.

FIG. 7 is a flowchart representing processing procedures involved in PCC/SCC switching at a communication terminal in the wireless communication system according to the first embodiment.

FIG. 8 is a diagram to describe a process to avoid continuous operation of PCC/SCC switching at the wireless communication system according to the first embodiment.

FIG. 9 is a schematic diagram representing an example of a component carrier (PCC/SCC) switching process at a wireless communication system according to a second embodiment.

FIG. 10 is a sequence chart representing an overall processing of PCC/SCC switching at the wireless communication system according to the second embodiment.

FIG. 11 is a sequence chart representing an overall processing of PCC/SCC switching at a wireless communication system according to a third embodiment.

FIG. 12 is a sequence chart representing an overall processing of PCC/SCC switching at a wireless communication system according to a fourth embodiment.

FIG. 13 is a sequence chart representing an overall processing of PCC/SCC switching at a wireless communication system according to a fifth embodiment.

### DESCRIPTION OF EMBODIMENTS

Embodiments of the present invention will be described in detail with reference to the drawings. In the drawings, the same or corresponding elements have the same reference characters allotted, and description thereof will not be repeated.

### A. OVERALL CONFIGURATION OF WIRELESS COMMUNICATION SYSTEM

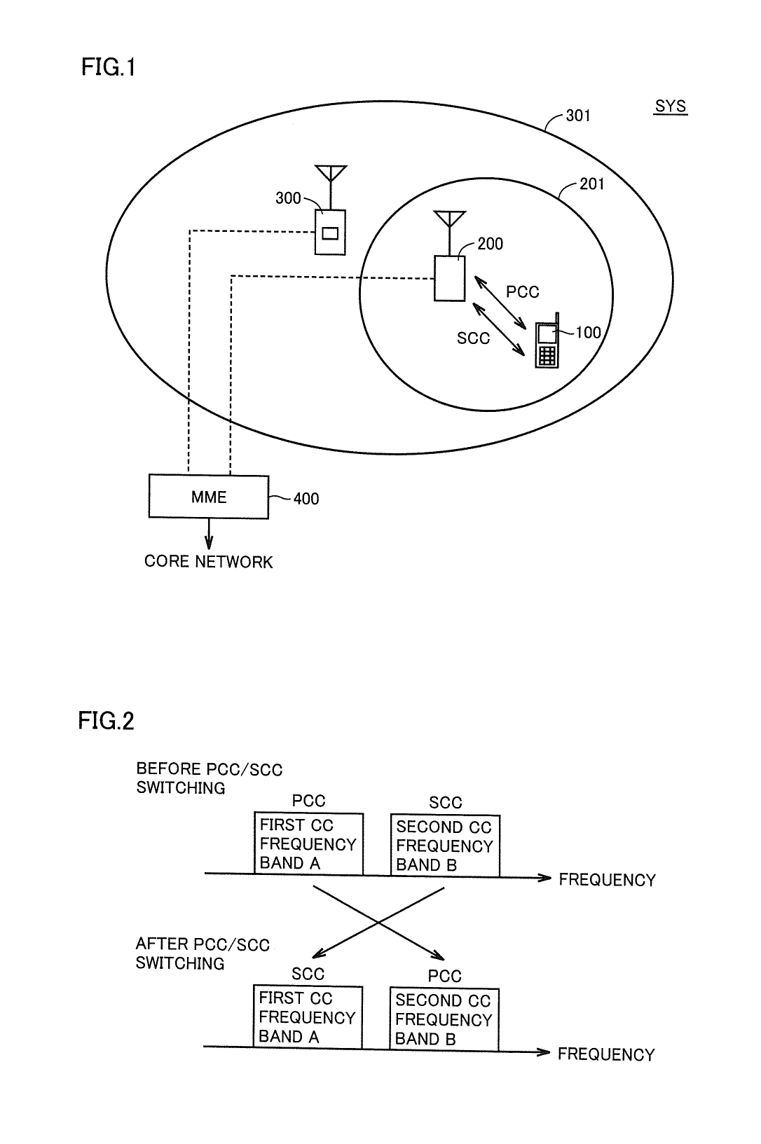

FIG. 1 schematically represents an overall configuration of a wireless communication system SYS envisaged in an embodiment. As a typical example, wireless communication system SYS is assumed to support a communication scheme according to the LTE-A specification or a specification conforming thereto.

Referring to FIG. 1, a wireless communication system SYS includes a Home evolved Node B (hereinafter, also referred to as “HeNB base station”) 200, and an evolved node B (hereinafter, also referred to as “eNB base station”) 300. HeNB base station 200 and eNB base station 300 may also be generically referred to simply as “base station”. HeNB base station 200 provides a service area 201, whereas eNB base station 300 provides a service area 301. Service area 201 provided by HeNB base station 200 is smaller than service area 301 provided by eNB base station 300. Service area 201 provided by HeNB base station 200 is also referred to as a “home cell”, whereas service area 301 provided by eNB base station 300 is also referred to as a “macrocell”.

HeNB base station 200 and eNB base station 300 are connected to a MME (Mobility Management Entity) 400. MME 400 provides control of setting/opening a session (connection) for packet communication as well as handover (switching of base station). MME 400 transfers user data transmitted on a core network through a core network control device (not shown) supporting SAE gateway (System Architecture Evolution Gateway).

Although only one HeNB base station 200 and one eNB base station 300 are shown in FIG. 1 for the sake of convenience, the number of such base stations is determined appropriately depending upon the system. Similarly, the number of MMEs 400 and gateways, connection topology, and the like are set appropriately according to the system. For example, HeNB base station 200 and eNB base station 300 may be connected to different MMEs 400.

### B. CARRIER AGGREGATION

It is assumed that wireless communication system SYS shown in FIG. 1 supports carrier aggregation. For example, it is assumed that communication terminal 100 shown in FIG. 1 communicates with HeNB base station 200 through two or more component carriers (frequency band). In other words, in wireless communication system SYS, communication is allowed between a base station (HeNB base station 200) and a communication terminal 100 through a plurality of frequency bands.

When communicating with HeNB base station 200 through two or more component carriers, at least one component carrier is used as the PCC (Primary Component Carrier), and the remaining at least one component carrier is used as a SCC (Secondary Component Carrier). In the case where there are many available component carriers, a plurality of SCCs are used at the same time.

The component carrier used as the PCC includes a PUCCH (Physical Uplink Control Channel), whereas the component carrier used as a SCC does not include a PUCCH. In other words, the PCC corresponds to the main frequency band, whereas a SCC corresponds to a sub frequency band.

Since an uplink control signal from communication terminal 100 is sent out on the PUCCH included in the PCC, the communication quality of the component carrier used as the PCC must be maintained at a favorable state. Therefore, the component carrier used as the PCC must have a communication quality ensured, equal to or higher than the communication quality of the component carrier used as a SCC.

Since the communication quality of the component carrier used as the PCC must be maintained at a favorable state, the component carrier used as the PCC, among the plurality of available component carriers, is switched appropriately according to the communication status.

FIG. 2 is a schematic diagram to describe a component carrier (PCC/SCC) switching process at wireless communication system SYS shown in FIG. 1.

FIG. 2 corresponds to an example at a certain point in time, using a first component carrier (frequency band A) as the PCC, and a second component carrier (frequency band B) as a SCC (prior to PCC/SCC switching). It is assumed that HeNB base station 200 has determined that the PCC communication quality is degraded under this state. Accordingly, a switching process between the PCC and SCC is initiated.

Following completion of this switching process, the first component carrier (frequency band A) will be used as a SCC, and the second component carrier (frequency band B) will be used as the PCC (after PCC/SCC switching).

Each embodiment will be described mainly focusing on the component carrier switching process. Hereinafter, this component carrier switching is also referred to as “PCC/SCC switching.”

### C. OVERVIEW OF PROBLEM AND SOLVING MEANS

According to the current specification, in the case where communication terminal 100 is communicating with eNB base station 300 through two or more component carriers, a determination is made that the component carrier switching (PCC/SCC switching corresponding to state) process is implemented utilizing a handover process.

The reason why a handover process is used is because a process is required similar to that when communication terminal 100 moves from cell to cell, such as RACH (Random Access Channel) process and/or Cell_ID modifying notification process towards MME 400 in accordance with PCC/SCC switching since eNB base station 300 that is a macrocell base station sets a different Cell_ID for the PCC and SCC.

Usage of such a handover process generally induces the problem that the user data throughput is spontaneously degraded during the handover process.

In view of the foregoing, the usage of only one Cell_ID for HeNB base station 200 that is the home cell base station is defined in the specification. Therefore, the same Cell_ID will be set for the PCC and SCC even in the case where communication terminal 100 communicates with HeNB base station 200 through two or more component carriers. This is an aspect that is characterizingly different from the carrier aggregation with eNB base station 300 that is a macrocell base station.

At the current stage, the switching process between the PCC and SCC at HeNB base station 200 that has the same Cell_ID set for the PCC and SCC has not yet been defined. In the present embodiment, a simpler PCC/SCC switching scheme is proposed, instead of the scheme employed at a macrocell base station.

Specifically, one of HeNB base station 200 and communication terminal 100 notifies, when a state is detected in which the frequency band to be used as the PCC (main frequency band) among a plurality of component carriers (frequency band) is to be switched, the other of HeNB base station 200 and communication terminal 100 of a switching preparation request.

In other words, two approaches are conceived, one governed by HeNB base station 200 to determine the necessity of and execute PCC/SCC switching (refer to first to fourth embodiments described afterwards), and the other governed by communication terminal 100 to determine the necessity of and execute PCC/SCC switching (refer to the fifth embodiment described afterwards).

The other of HeNB base station 200 and communication terminal 100 (the under-governed side) determines whether in a state in which the frequency band used as the main frequency band is to be switched in response to a switching preparation request. In response to a determination of being in a state in which the frequency band used as the main frequency band is to be switched, the other of HeNB base station 200 and communication terminal 100 notifies the one of HeNB base station 200 and communication terminal 100 (governing side) of frequency band switching preparation completion.

The one of HeNB base station 200 and communication terminal 100 (governing side) initiates a switching process of the frequency band used as the main frequency band between HeNB base station 200 and communication terminal 100 in response to switching preparation completion.

Details of each embodiment will be described hereinafter.

### D. DEVICE CONFIGURATION

A hardware configuration of each entity constituting wireless communication system SYS shown in FIG. 1 will be described first.

### d1: Configuration of Communication Terminal 100

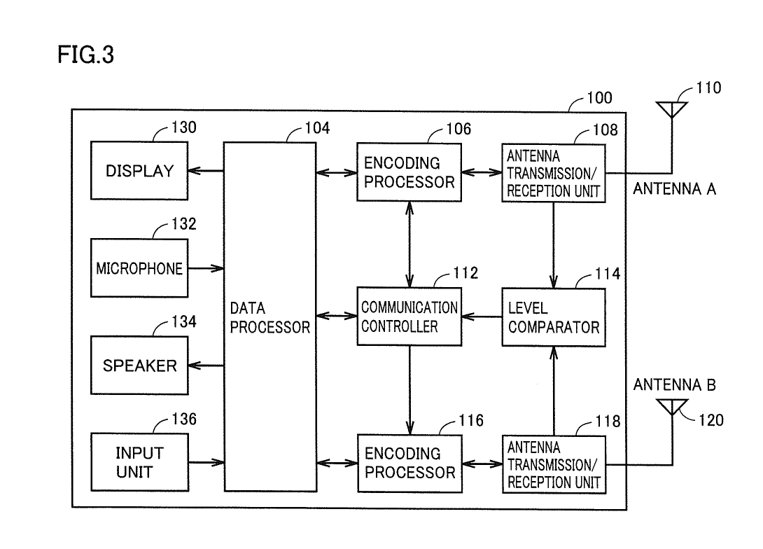

A configuration of communication terminal 100 used in wireless communication system SYS shown in FIG. 1 will be described. FIG. 3 is a block diagram of a hardware configuration of communication terminal 100 used in wireless communication system SYS shown in FIG. 1.

Referring to FIG. 3, communication terminal 100 includes a data processor 104, encoding processors 106, 116, antenna transmission/reception units 108, 118, antennas 110, 120, a communication controller 112, and a level comparator 114. Communication terminal 100 shown in FIG. 3 includes two wireless communication circuits of system A (frequency band A) and system B (frequency band B), allowing two component carriers to be used simultaneously.

Data processor 104 is the control entity to realize the functions provided by communication terminal 100. Data processor 104 determines the communication status based on information from communication controller 112, and controls the transmission/reception of a control signal and user data at each of encoding processor 106 (system A) and encoding processor 116 (system B).

Encoding processors 106 and 116 are connected to antenna transmission/reception units 108 and 118, respectively, to decode and output to data processor 104 a sequence of signals received from a corresponding antenna transmission/reception unit, and to decode and output to a corresponding antenna transmission/reception unit a control signal and user data received from data processor 104. Encoding processors 106 and 116 perform an encoding/decoding process according to a control command from communication controller 112.

Antenna transmission/reception units 108 and 118 are connected to antennas 110 and 120, respectively, to demodulate and output to a corresponding encoding processor a radio signal received from a corresponding antenna, and to demodulate and output to a corresponding antenna a sequence of signals received from a corresponding encoding processor.

Antennas 110 and 120 transmit/receive a radio signal to/from one or more base stations. For the sake of convenience, antennas 110 and 120 are also referred to as “antenna A” and “antenna B”, respectively.

Level comparator 114 compares the level of radio signals received at antenna transmission/reception units 108 and 118 to output the comparison result to communication controller 112.

Communication controller 112 determines the communication state at each point in time based on the comparison result from level comparator 114 to output the determination result to data processor 104 and to output a control command to encoding processors 106 and 116.

Communication terminal 100 has a configuration as a communication terminal such as a display 130 to show various information, a microphone 132 to obtain the voice of a user and the like, a speaker 134 to play the received voice, and an input unit 136 to accept a user's manipulation.

Each of the functions constituting communication terminal 100 shown in FIG. 3 may be implemented in software or hardware.

### d2: Configuration of HeNB Base Station 200

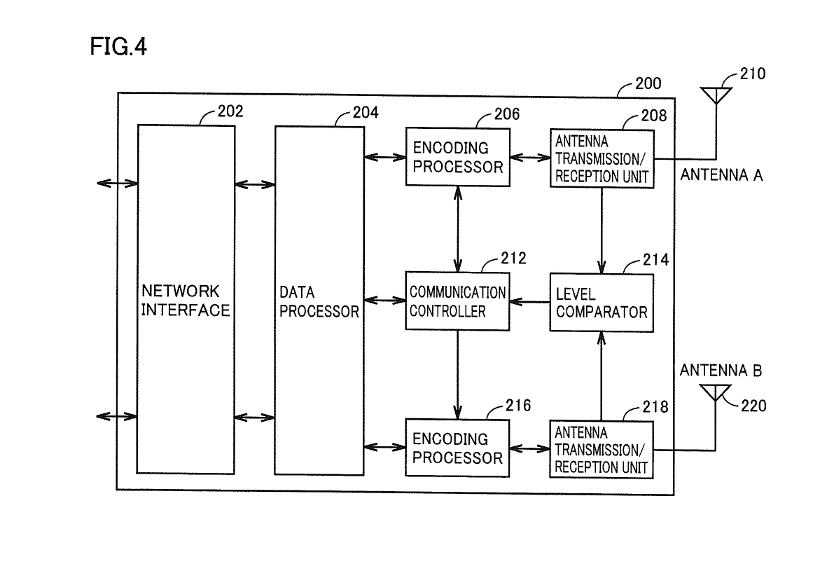

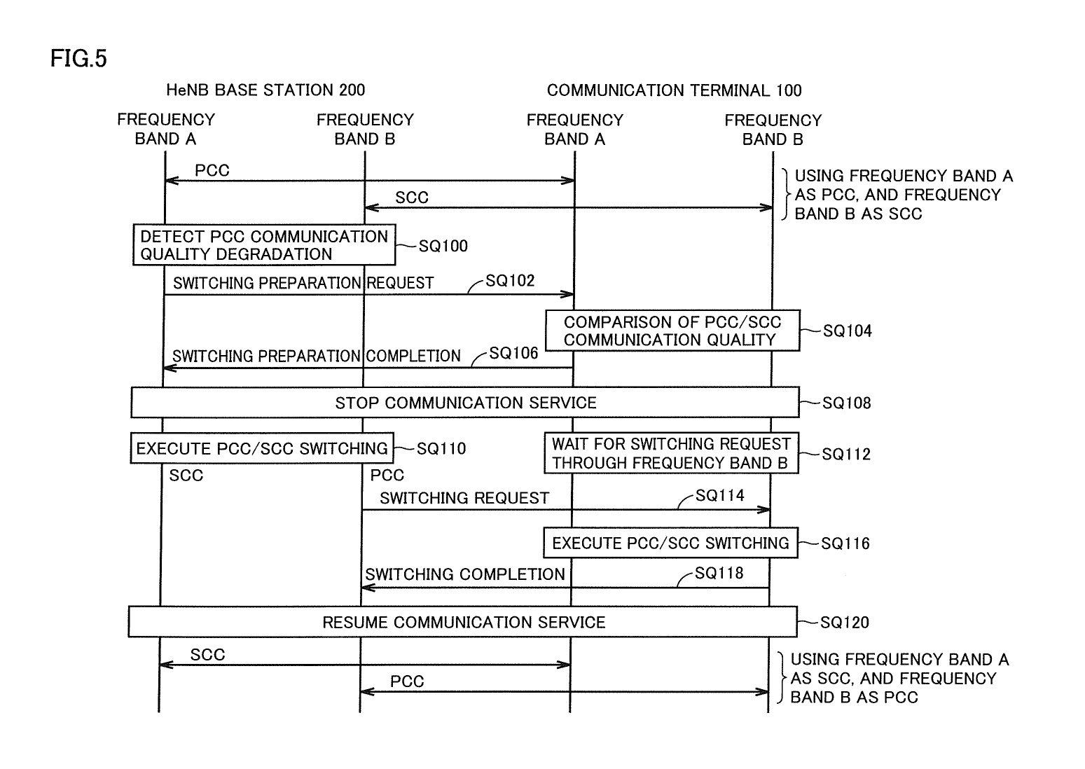

A configuration of HeNB base station 200 used in wireless communication system SYS shown in FIG. 1 will be described. FIG. 4 is a block diagram representing a hardware configuration of HeNB base station 200 used in wireless communication system SYS shown in FIG. 1.

Referring to FIG. 4, HeNB base station 200 includes a network interface 202, a data processor 204, encoding processors 206, 216, antenna transmission/reception units 208, 218, antennas 210, 220, a communication controller 212, and a level comparator 214. Although an example of a HeNB base station 200 having two wireless communication circuits of system A (frequency band A) and system B (frequency band B) is shown for the sake of convenience in FIG. 4, wireless communication circuits identical in number with component carriers available at HeNB base station 200 are preferably mounted.

Network interface 202 transfers user data to/from MME 400, the core network, and the like. Network interface 202 outputs user data received from MME 400 or the like to data processor 204, and outputs user data received from data processor 204 to MME 400 and the like.

Data processor 204 is the control entity to realize the functions provided by HeNB base station 200. Data processor 204 determines the communication state based on information from communication controller 212, and controls the transmission/reception of a control signal and/or user data at each of encoding processor 206 (system A) and encoding processor 216 (system B).

Encoding processors 206 and 216 are connected to antenna transmission/reception units 208 and 218, respectively, to decode and output to data processor 204 a sequence of signals received from a corresponding antenna transmission/reception unit, and to decode and output to a corresponding antenna transmission/reception unit a control signal and/or user data received from data processor 204. Encoding processors 206 and 216 perform an encoding/decoding process according to a control command from communication controller 212.

Antenna transmission/reception units 208 and 218 are connected to antennas 210 and 220, respectively, to demodulate and output to a corresponding encoding processor a radio signal received from a corresponding antenna, and to demodulate and output to a corresponding antenna a sequence of signals received from a corresponding encoding processor.

Antennas 210 and 220 transmit/receive a radio signal to/from one or more communication terminals 100. For the sake of convenience, antennas 210 and 220 are also referred to as “antenna A” and “antenna B”, respectively.

Level comparator 214 compares the level of radio signals received at each of antenna transmission/reception units 208 and 218 to output the comparison result to communication controller 212.

Communication controller 212 determines the communication state at that point in time based on the comparison result from level comparator 214 to output the determination result to data processor 204 and to output a control command to encoding processors 206 and 216.

Each of the functions constituting HeNB base station 200 shown in FIG. 4 may be realized by a processor executing a program prestored in a non-volatile memory or the like. In this case, an operation device (processor) such as a CPU (Central Processing Unit) or DSP (Digital Signal Processor) executes a set of instructions installed in advance.

Alternatively, a portion or all of the functions shown in FIG. 4 may be mounted as dedicated hardware (typically, integrated circuit). In this case, circuitry realizing all the functions may be implemented as one chip. Moreover, a SoC (System On a Chip) having components such as a processor, memory, controller for a peripheral device implemented as one chip may be employed.

### d3: Other Configuration

eNB base station 300 and MME 400 used in wireless communication system SYS shown in FIG. 1 may be implemented by using well-known architectures. Therefore, detailed description will not be provided here.

### E: FIRST EMBODIMENT

### e1: General

As the first embodiment, a scheme of executing PCC/SCC switching, governed by HeNB base station 200, will be described. This scheme is an individual switching scheme of a communication terminal based on the wireless environment condition.

HeNB base station 200 is capable of comparing the communication quality between the PCC and SCC. In other words, HeNB base station 200 has the function of determining the communication quality of the frequency band (component carrier) used as the main frequency band (PCC). This function is realized mainly by communication controller 212 and level comparator 214 (FIG. 4).

In the case where HeNB base station 200 detects degradation in the communication quality at the PCC during communication with communication terminal 100 using carrier aggregation, a notification of a preparation initiation request required for executing PCC/SCC switching is sent (hereinafter, this notification is also referred to as “PCC/SCC switching preparation request”) exclusively to communication terminal 100 currently in a communication utilizing carrier aggregation.

For a determination condition to detect degradation in communication quality, reduction in RSSI (Received Signal Strength Indicator) that is an index in the wireless environment, degradation in Ec/No (Energy per chip to Noise radio), degradation in SIR (Signal to Interference Ratio), a data processing result as the information included in the PUCCH and the like can be used.

The PCC/SCC switching preparation request may include CC information indicating which of SCC is to be switched for the PCC.

Upon receiving a PCC/SCC switching preparation request, communication terminal 100 measures the communication quality of the PCC and specified SCC to compare the measured results as a preparation to execute PCC/SCC switching. When a determination is made that switching between the PCC and specified SCC will lead to improvement in communication throughput, communication terminal 100 notifies HeNB base station 200 of completing PCC/SCC switching preparation through the PUCCH.

Upon receiving PCC/SCC switching preparation completion through the PUCCH, HeNB base station 200 executes PCC/SCC switching, and notifies communication terminal 100 of switching completion. Upon receiving a switching request, communication terminal 100 notifies HeNB base station 200 about switching completion through the PUCCH of the switched PCC.

### e2: Overall Procedure

The overall processing of PCC/SCC switching at wireless communication system SYS according to the first embodiment will be described hereinafter.

FIG. 5 is a sequence chart representing the overall processing of PCC/SCC switching at wireless communication system SYS according to the first embodiment. Referring to FIG. 5, as the initial state, it is assumed that HeNB base station 200 is communicating with communication terminal 100 using frequency band A as the PCC through antenna A and frequency band B as the SCC through antenna B. In other words, communication terminal 100 is communicating with HeNB base station 200 through a plurality of frequency bands.

During communication with communication terminal 100, level comparator 214 of HeNB base station 200 monitors the communication quality of frequency band A and frequency band B. Specifically, level comparator 214 of HeNB base station 200 compares the communication quality between the PCC and SCC (sequence SQ100).

In the case where level comparator 214 of HeNB base station 200 detects that the communication quality of frequency band A used as the PCC is lower than the communication quality of frequency band B used as the SCC, and determines that modifying the frequency band used as the PCC will lead to improving the communication throughput, a PCC/SCC switching preparation request is sent to communication terminal 100 (sequence SQ102). This PCC/SCC switching preparation request is transmitted through frequency band A used as the PCC.

Level comparator 214 of HeNB base station 200 compares the communication quality between the PCC and SCC based on information extracted at antenna transmission/reception units 208 and 218. The items to compare the communication quality between the PCC and SCC include parameters indicating the communication quality between radio zones such as RSSI, Ec/No, and SIR. Although FIG. 4 represents an example of a configuration in which level comparator 214 verifies the communication quality in radio zones, a comparison logic provided at data processor 204 may be used alternatively. In this case, the communication quality may be compared using parameters related to degradation in data transmission/reception such as the error rate and CQI (Channel Quality Indicator), the delay time before control data is received, and the like. The comparison result detected at level comparator 214 is output to communication controller 212, which monitors the series of processing related to PCC/SCC switching.

In other words, the notification means (data processor 204, communication controller 212 and level comparator 214) provided at HeNB base station 200 notifies communication terminal 100 of a switching preparation request when a state is detected in which the frequency band used as the main frequency band (PCC) among the plurality of frequency bands is to be switched.

Referring to FIG. 5 again, upon receiving a PCC/SCC switching preparation request from HeNB base station 200, level comparator 114 of communication terminal 100 compares the communication quality between the PCC and SCC (sequence SQ104). The items used for comparing the communication quality between the PCC and SCC at level comparator 114 of communication terminal 100 are similar to those used by level comparator 214 of HeNB base station 200.

When a determination is made that the communication quality of frequency band A used as the PCC is degraded and the communication quality of frequency band B used as the SCC is better as a result of level comparator 114 of communication terminal 100 comparing the communication quality between the PCC and SCC, communication terminal 100 notifies HeNB base station 200 of completing PCC/SCC switching preparation (sequence SQ106).

In other words, the determination means (data processor 104, communication controller 112 and level comparator 114) provided at communication terminal 100 determines, in response to a switching preparation request, whether in a state in which the frequency band used as the main frequency band (PCC) is to be switched. Then, the notification means (communication controller 112) provided at communication terminal 100 notifies HeNB base station 200 of completing the frequency band switching preparation in response to a determination of being in a state in which the frequency band used as the main frequency band (PCC) is to be switched.

Following notification of PCC/SCC switching preparation completion, communication terminal 100 temporarily stops the communication service (sequence SQ108), and waits for a PCC/SCC switching request from HeNB base station 200 through frequency band B utilized as the SCC (sequence SQ112).

Upon receiving PCC/SCC switching preparation completion from communication terminal 100, HeNB base station 200 temporarily stops the communication service (sequence SQ108), and executes PCC/SCC switching (sequence SQ110). In other words, HeNB base station 200 sets frequency band A that was used as the PCC therebefore as the SCC and sets frequency band B that was used as the SCC therebefore as the PCC.

Then, HeNB base station 200 notifies communication terminal 100 of a PCC/SCC switching request at frequency band B (sequence SQ114). In response to this PCC/SCC switching request, communication terminal 100 is notified that usage of frequency band B as the PCC and usage of frequency band A as the SCC is initiated. In other words, following completion of frequency band switching at HeNB base station 200, communication terminal 100 is notified of a switching request designating frequency band switching through the frequency band used as the new main frequency band (PCC).

Upon receiving a PCC/SCC switching request through frequency band B, communication terminal 100 can recognize that HeNB base station 200 has executed PCC/SCC switching. Accordingly, communication terminal 100 also executes PCC/SCC switching (sequence SQ 116). In other words, communication terminal 100 sets frequency band A as the SCC and frequency band B as the PCC. Then, communication terminal 100 notifies HeNB base station 200 of completing PCC/SCC switching through frequency band B set as the PCC (sequence SQ118).

Upon receiving PCC/SCC switching completion from communication terminal 100, HeNB base station 200 recognizes that communication terminal 100 has executed PCC/SCC switching. Then, communication service is resumed by HeNB base station 200 and communication terminal 100 using frequency band B as the PCC and frequency band A as the SCC (sequence SQ120).

Thus, wireless communication system SYS has the function of initiating a switching process of the frequency band used as the main frequency band (PCC) between HeNB base station 200 and communication terminal 100 in response to PCC/SCC switching preparation completion.

The overall processing shown in FIG. 5 may be modified as set forth below.

Each message transferred between communication terminal 100 and HeNB base station 200 may notified, not just through the frequency band used as the PCC, but through the two frequency bands used as the PPC and SCC. For example, a notification of a PCC/SCC switching preparation request from HeNB base station 200 may be sent to communication terminal 100 through the two frequency bands of frequency A and frequency B.

Moreover, the usage of two frequency bands can include the mode of independently transmitting the same two messages through respective frequency bands, or transmitting one message through two frequency bands. In the case of the latter, the method employed may divide one message at the transmission side and send the divided messages through the two allocated frequency bands, and then combine the data received through each of the two frequency bands at the reception side to constitute one message.

### e3: Processing Procedure at HeNB Base Station

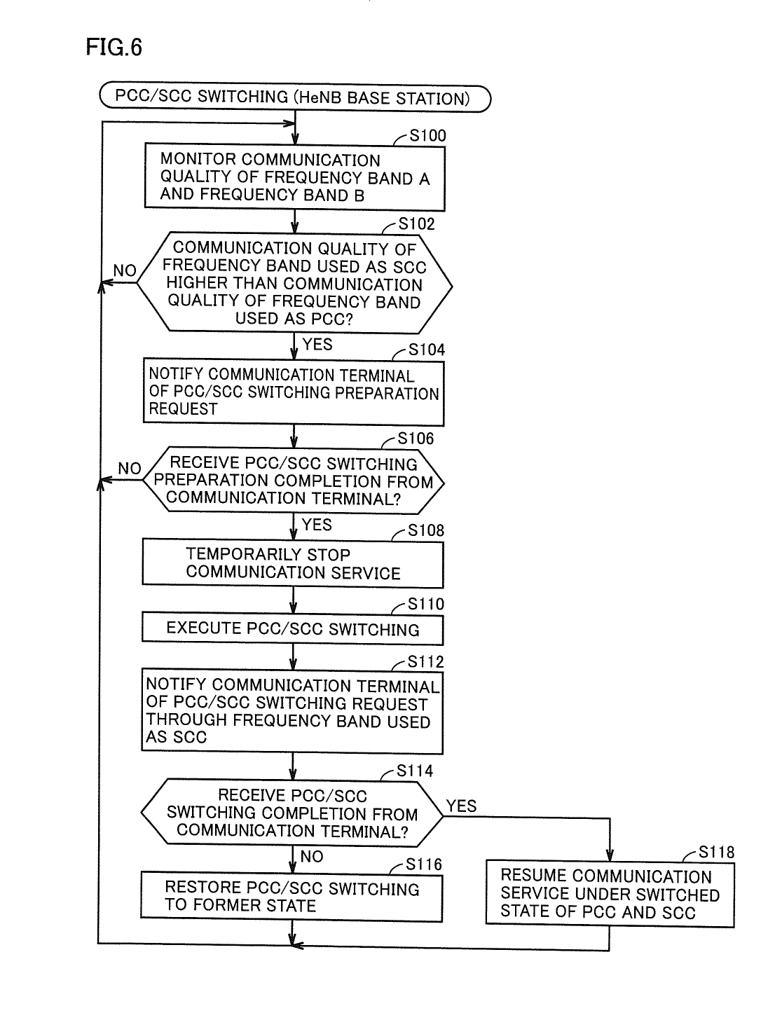

The processing procedures at HeNB base station 200 according to the first embodiment will be described hereinafter. FIG. 6 is a flowchart of the processing procedures involved in PCC/SCC switching at HeNB base station 200 in wireless communication system SYS according to the first embodiment.

Referring to FIG. 6, level comparator 214 of HeNB base station 200 monitors the communication quality of frequency A and frequency B (step S100). Then, communication controller 212 of HeNB base station 200 determines whether the communication quality of the frequency band used as the SCC is higher than the communication quality of the frequency band used as the PCC (step S102). When the communication quality of the frequency band used as the PCC is lower than the communication quality of the frequency band used as the SCC (NO at step S102), control returns to step S100.

In contrast, when the communication quality of the frequency band used as the SCC is higher than the communication quality of the frequency band used as the PCC (YES at step S102), communication controller 212 of HeNB base station 200 notifies communication terminal 100 of a PCC/SCC switching preparation request (step S104). Then, communication controller 212 of HeNB base station 200 determines whether PCC/SCC switching preparation completion has been received from communication terminal 100 (step S106).

In the case where PCC/SCC switching preparation completion has not been received from communication terminal 100 during a predetermined period of time (NO at step S106), control returns to step S100.

In contrast, when PCC/SCC switching preparation completion has been received from communication terminal 100 (YES at step S106), communication controller 212 of HeNB base station 200 temporarily stops the communication service (step S108), and executes PCC/SCC switching (step S110). Communication controller 212 of HeNB base station 200 notifies communication terminal 100 of a PCC/SCC switching request through the frequency band used as the SCC (step S112). Then, communication controller 212 of HeNB base station 200 determines whether PCC/SCC switching completion has been received from communication terminal 100 (step S114).

When PCC/SCC switching completion has not been received from communication terminal 100 during the predetermined period of time (NO at step S114), communication controller 212 of HeNB base station 200 restores the executed PCC/SCC switching executed at step S110 to the former state (step S116). Then, control returns to step S100.

When PCC/SCC switching completion has been received from communication terminal 100 (YES at step S114), communication controller 212 of HeNB base station 200 resumes the communication service under the switched state between the PCC and SCC (step S118). Then, the process of steps S100 and et seq. is repeated.

### e4: Processing Procedure at Communication Terminal

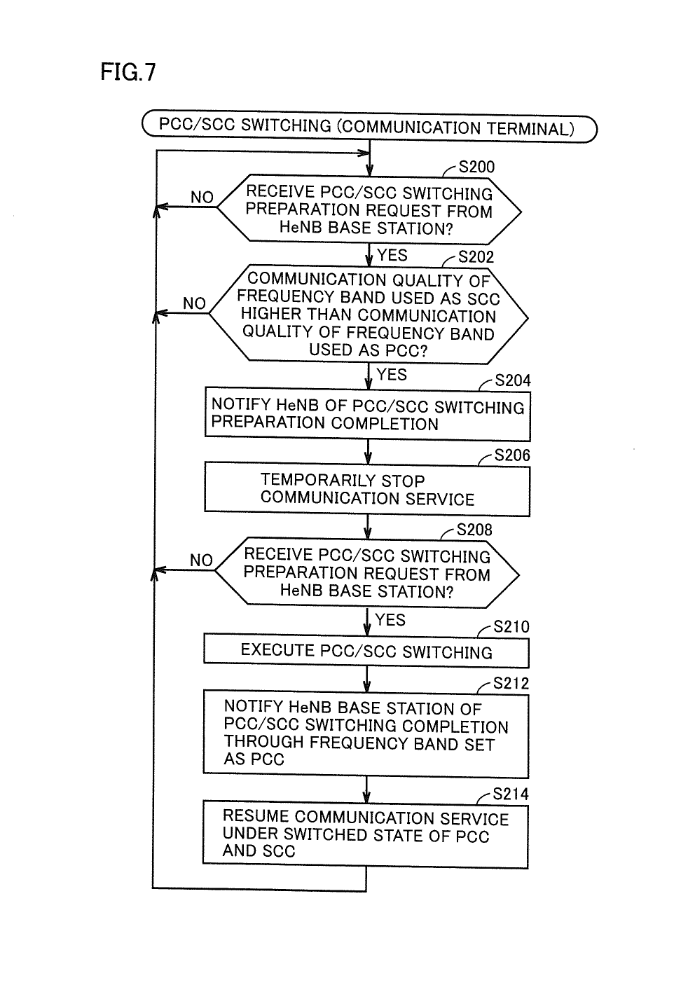

The processing procedures at communication terminal 100 according to the first embodiment will be described hereinafter. FIG. 7 is a flowchart of the processing procedures involved in PCC/SCC switching at communication terminal 100 in wireless communication system SYS according to the first embodiment.

Referring to FIG. 7, communication controller 112 of communication terminal 100 determines whether a PCC/SCC switching preparation request has been received from HeNB base station 200 (step S200). When a PCC/SCC switching preparation request has not been received from HeNB base station 200 (NO at step S200), control returns to step S200.

In contrast, when a PCC/SCC switching preparation request has been received from HeNB base station 200 (YES at step S200), communication controller 112 of communication terminal 100 determines whether the communication quality of the frequency band used as the SCC is higher than the communication quality of the frequency band used as the PCC (step S202). When the communication terminal of the frequency band used as the PCC is lower than the communication quality of the frequency band used as the SCC (NO at step S202), control returns to step S200.

In contrast, in the case where the communication quality of the frequency band used as the SCC is higher than the communication quality of the frequency band used as the PCC (YES at step S202), communication controller 112 of communication terminal 100 notifies HeNB base station 200 of PCC/SCC switching preparation completion (step S204). Then, communication controller 112 of communication terminal 100 temporarily stops the communication service (step S206). Next, communication controller 112 of communication terminal 100 determines whether a PCC/SCC switching request has been received from HeNB base station 200 (step S208). When a PCC/SCC switching request has not been received from HeNB base station 200 during a predetermined period of time (NO at step S208), control returns to step S200.

In contrast, when a PCC/SCC switching request has been received from HeNB base station 200 (YES at step S208), communication controller 112 of communication terminal 100 executes PCC/SCC switching (step S210). Communication controller 112 of communication terminal 100 notifies HeNB base station 200 of PCC/SCC switching completion through the frequency band set as the PCC (step S212). Then, communication controller 112 of communication terminal 100 resumes the communication service under the state where the PCC and SCC are switched (step S214). The process of steps S200 and et seq. is repeated,

### e5: Exemplified Modification

Even in the case where HeNB base station 200 notifies communication terminal 100 of a PCC/SCC switching preparation request in FIG. 5 set forth above, communication terminal 100 may respond by sending a NACK (Not ACKnowledgment) signal with respect to the PCC/SCC switching preparation request in the case where a determination is made that the communication quality of frequency band A used as the PCC is better as a result of comparing the communication quality on the side of communication terminal 100. Upon receiving a NACK signal with respect to a PCC/SCC switching preparation request, HeNB base station 200 stops PCC/SCC switching, and continues the communication service in the original state.

Alternatively, a reprocessing request may be sent, aside from a NACK signal, from the communication terminal 100 side. For example, in response to a notification of a reprocessing request from communication terminal 100, HeNB base station 200 performs the process again starting from the measurement of communication quality.

Thus, in the case where communication terminal 100 transmits a NACK signal or a reprocessing request to HeNB base station 200, it is preferable to add the process set forth below such that communication terminal 100 does not send a NACK signal or reprocessing result in succession.

In other words, in the case where the communication quality determination result differs between HeNB base station 200 and communication terminal 100, there is a possibility of a PCC/SCC switching operation occurring in succession. A process is to be included to avoid such a situation. In other words, a process is added to avoid the execution of PCC/SCC switching in succession within a predetermined period of time.

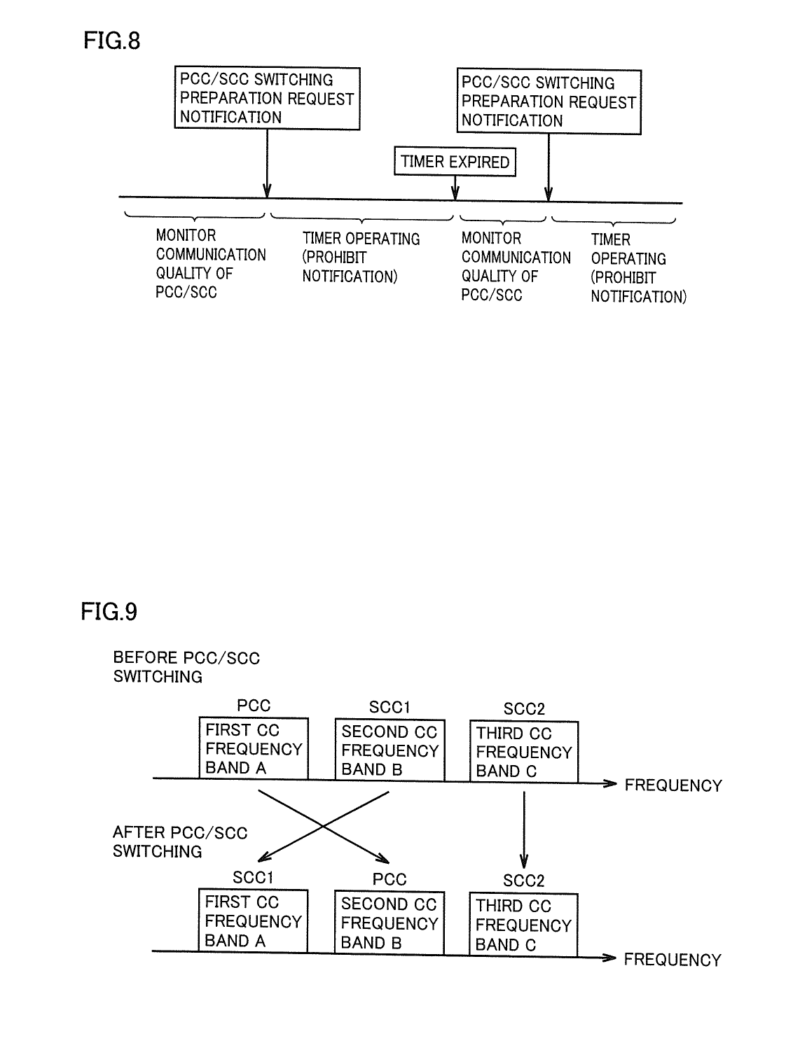

FIG. 8 is a diagram to describe the process of avoiding continuous PCC/SCC switching operation at wireless communication system SYS according to the first embodiment. Referring to FIG. 8, HeNB base station 200 prohibits, after sending a PCC/SCC switching preparation request to communication terminal 100, notifying again a PCC/SCC switching preparation request for a predetermined period of time. For example, consider the case where HeNB base station 200 sends a notification of a PCC/SCC switching preparation request to communication terminal 100, and receives a NACK signal from communication terminal 100 in response. In this case, when a determination is made that the communication quality of frequency band B used as the SCC is better as a result of comparing again the communication quality between frequency band A used as the PCC and frequency band B used as the SCC, a PCC/SCC switching preparation request will be sent repeatedly during a short period of time. By providing the aforementioned notification prohibition period of time, the event of such repeated notification can be avoided.

As a method of providing such a notification prohibition term, a timer that is activated in response to a notification of a PCC/SCC switching preparation request is provided to ensure the interval of a predetermined period of time. HeNB base station 200 will not send the next PCC/SCC switching preparation request until this timer expires.

### e6: Advantage

According to wireless communication system SYS of the present embodiment, PCC/SCC switching can be performed by simplified procedures when HeNB base station 200 and communication terminal 100 are communicating utilizing carrier aggregation.

Specifically, since the Cell_ID does not have to be modified in wireless communication system SYS according to the present embodiment, notification towards MME 400 and the like is not required in the execution of PCC/SCC switching. In other words, only the processing between HeNB base station 200 and communication terminal 100 is required. Accordingly, the processing load on the core network can be reduced.

Moreover, the event of spontaneous degradation of the user data throughput, such as in the case where a handover process is used, can be avoided. Therefore, the average throughput can be improved. Complicated processing such as RACH processing is also not required.

In carrier aggregation, the PCC includes a control signal that monitors the communication service. Therefore, there is generally the tendency of the PCC frequency usage becoming higher. From the standpoint of HeNB base station 200, increase of communication terminals 100 utilizing a certain frequency band as the PCC causes a higher usage efficiency of that frequency band, resulting in increase of the signal processing load on that certain frequency band. By switching the frequency band used as the PCC with the frequency band used as the SCC taking advantage of the PCC/SCC switching as in the present embodiment, the signal processing load on a certain frequency band can be alleviated. In other words, since the PUCCH is handled only through the PCC, a SCC that does not handle the PUCCH has more room for resource allocation than the PCC. As such, the frequency band usage efficiency can be distributed.

Wireless communication system SYS according to the present embodiment employs an individual switching scheme of communication terminal 100 based on a wireless environment condition. In other words, since the process of PCC/SCC switching is executed only for a communication terminal 100 whose wireless environment is degraded, the signal processing load at HeNB base station 200 can be reduced. Moreover, the PCC/SCC switching can be handled in a flexible manner according to the wireless environment of each communication terminal 100.

### F: EXEMPLIFIED MODIFICATION OF FIRST EMBODIMENT

As an exemplified modification of the first embodiment, the scheme for executing PCC/SCC switching when the available resource is insufficient will be described. This example is directed to a communication terminal individual switching method according to resource allocation.

The previous description of the first embodiment was based on, but not limited to an example where PCC/SCC switching is initiated ascribable to degradation in the wireless environment. PCC/SCC switching may be initiated ascribable to insufficient resource. For example, in the case where the resource in carrier component used as the PCC for HeNB base station 200 is insufficient while the resource in carrier component used as the SCC is available, PCC/SCC switching is executed for communication terminal 100 currently in communication with HeNB base station 200.

HeNB base station 200 according to an exemplified modification of the first embodiment has the function of determining whether the resource for the frequency band (component carrier) used as the main frequency band (PCC) is insufficient or not. This function is realized mainly by communication controller 212 and data processor 204 (FIG. 4).

In this case, the PCC/SCC switching process per se is similar to that described above in the first embodiment. Therefore, detailed contents of the process will not be repeated.

Namely, HeNB base station 200 monitors the state of the handled component carrier resource, and initiates the PCC/SCC switching process, triggered by the insufficient resource in the frequency band used as the PCC.

By employing the above-described communication terminal individual switching method by resource allocation, the following advantage can be provided, in addition to the advantages of the first embodiment set forth above. Specifically, the load of the resource in the component carrier used between HeNB base station 200 and communication terminal 100 can be distributed to avoid the heavy usage of a certain component carrier.

Further, since the component carrier resource distribution is equalized, a communication terminal 100 can be newly connected taking advantage of an available resource. In other words, the resource usage efficiency can be improved to allow more communication terminals 100 to be connected with HeNB base station 200.

### G: SECOND EMBODIMENT

### g1: General

PCC/SCC switching when there are a plurality of frequency bands used as the SCC will be described as the second embodiment.

FIG. 9 is a schematic diagram representing an example of a component carrier (PCC/SCC) switching process at wireless communication system SYS according to the second embodiment. The first embodiment has been described based on a method of executing a switching process between PCC and SCC in the state where frequency A is used as the PCC and frequency band B is used as a SCC. The second embodiment will be described based on a case of switching from the state where frequency band A is used as the PCC and frequency bands B and C are used as the first SCC (SCC1) and the second SCC (SCC2) to the state where frequency band B is used as the PCC and frequency band A is used as SCC1, as shown in FIG. 9. In the second embodiment, the plurality of frequency bands used in the communication between HeNB base station 200 and communication terminal 100 include a plurality of sub frequency bands (SCC).

### g2: Overall Procedure

The overall processing of PCC/SCC switching at wireless communication system SYS according to the second embodiment will be described hereinafter.

In the carrier aggregation using two component carriers (frequency bands) described in the first embodiment, communication terminal 100 does not have to be notified of the frequency band that is the subject of switching in the switching process of PCC and SCC since the frequency bands of the PCC and SCC that are the subject are apparent. In the case where three or more component carriers (frequency bands) are used, i.e. in the case where two or more SCCs are set, which of the frequency bands currently used as the SCC is to be used as the PCC must be specified.

To this end, a notification of a PCC/SCC switching preparation request including frequency band specification information is sent to communication terminal 100 in the second embodiment.

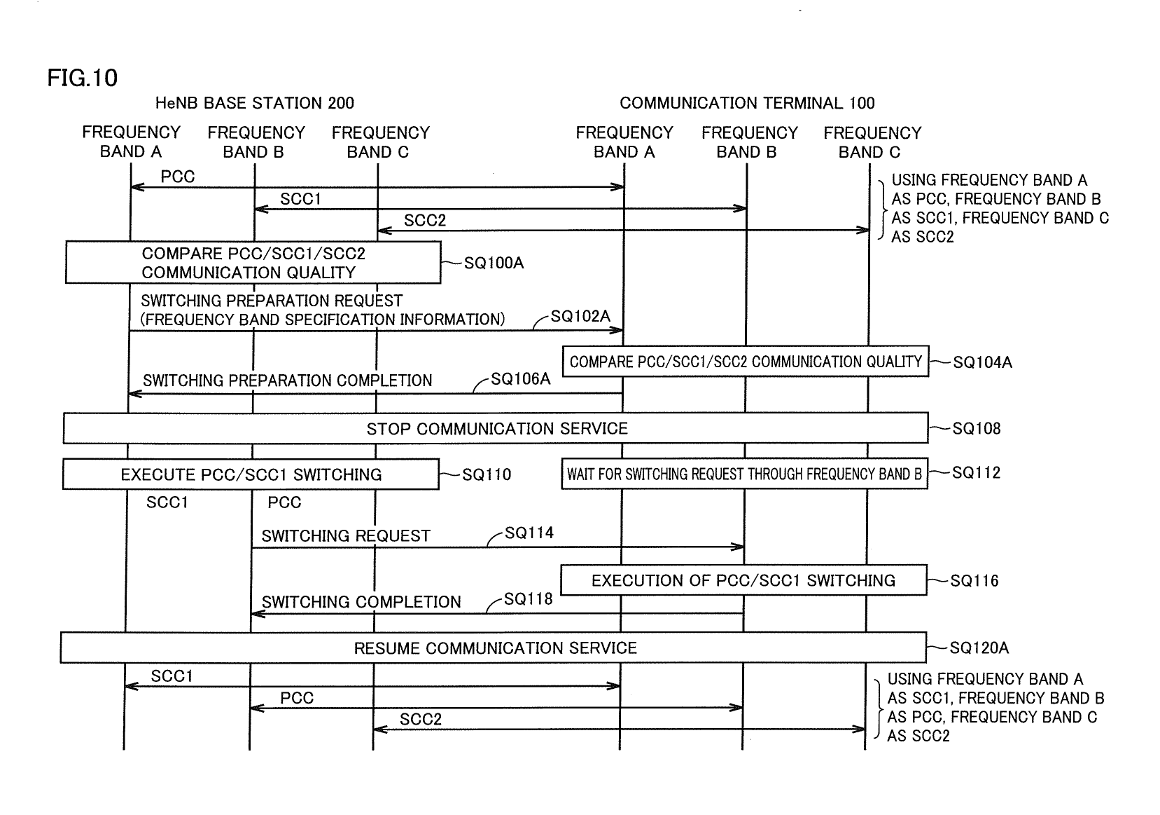

FIG. 10 is a sequence chart representing the overall processing of PCC/SCC switching at wireless communication system SYS according to the second embodiment. Referring to FIG. 10, it is assumed that, as the initial state, HeNB base station 200 is communicating with communication terminal 100 using frequency band A as the PCC, and frequency bands B and C as SCC1 and SCC2, respectively.

During communication with communication terminal 100, level comparator 214 of HeNB base station 200 monitors the communication quality of frequency band A, frequency band B and frequency band C. In other words, level comparator 214 of HeNB base station 200 compares the communication quality of the three frequency bands of PCC, SCC1 and SCC2 (sequence SQ100A).

When level comparator 214 of HeNB base station 200 determines that the communication quality of frequency band B used as SCC1 is most favorable as compared to the communication quality of other frequency bands, a notification of a PCC/SCC switching preparation request is sent to communication terminal 100 (sequence SQ102A). Here, HeNB base station 200 adds information indicating that frequency band B should be used as the PCC (frequency band specification information) into the PCC/SCC switching preparation request.

In other words, the notification means provided at HeNB base station 200 (data processor 204, communication controller 212 and level comparator 214) notifies communication terminal 100 of a switching preparation request when a state is detected in which the frequency band used as the main frequency band (PCC) among the plurality of frequency bands is to be switched. At this stage, the notification means provided at HeNB base station 200 sends a notification of a switching preparation request including information indicating the sub frequency band (SCC) that is the subject of switching.

Upon receiving a PCC/SCC switching preparation request from HeNB base station 200, level comparator 114 of communication terminal 100 monitors the communication quality of frequency bands A, B and C. In other words, level comparator 114 of communication terminal 100 compares the communication quality between the three frequency bands of PCC, SCC1 and SCC2 (sequence SQ104A).

When level comparator 214 of HeNB base station 200 determines that the communication quality of frequency band B used as SCC1 is most favorable as compared to the communication quality of other frequency bands, communication terminal 100 notifies HeNB base station 200 of PCC/SCC switching preparation completion (sequence SQ106A).

In other words, determination means (data processor 104, communication controller 112 and level comparator 114) provided at communication terminal 100 determines, in response to the switching preparation request, whether in a state in which the frequency band used as the main frequency band (PCC) is to be switched. Then, the notification means (communication controller 112) provided at communication terminal 100 notifies HeNB base station 200 of frequency band switching preparation completion in response to a determination of being in a state in which the frequency band used as the main frequency band (PCC) is to be switched.

Following notification of PCC/SCC switching preparation completion, communication terminal 100 temporarily stops the communication service (sequence SQ108), and waits for a PCC/SCC switching request from HeNB base station 200 through frequency band B used as SCC1 (sequence SQ112).

The remaining process is similar to the process with a corresponding sequence number in the sequence chart of FIG. 5. Therefore, detailed description will not be repeated.

Thus, by the PCC/SCC switching process set forth above, frequency band A is switched from the PCC to SCC1, frequency band B is switched from SCC1 to the PCC, and frequency band C is used as SCC2 to continue the communication service.

The overall processing shown in FIG. 10 may be modified as set forth below.

Sequence SQ104A was described based on an example where, following reception of a PCC/SCC switching preparation request, communication terminal 100 compares the communication quality of all the three frequency bands used, and selects the frequency band having the most favorable communication quality. However, the communication quality may be verified only for the frequency band that is the switching candidate. In the example shown in FIG. 10, the communication quality may be compared only between two frequency bands, i.e. frequency band A used as the PCC and frequency band B specified by HeNB base station 200, and determine which frequency band thereof has a better communication quality.

Although FIG. 10 has been described based on carrier aggregation using three frequency bands, the same applies to carrier aggregation using four or more frequency bands.

### g3: Processing Procedure at HeNB Base Station

The processing procedures at HeNB base station 200 according to the second embodiment differs from those of the first embodiment shown in FIG. 6 in the number of frequency bands of which communication quality is to be monitored (corresponding to step S100) and notifying a PCC/SCC switching preparation request including frequency band specification information (corresponding to step S104). Therefore, detailed description will not be repeated.

### g4: Processing Procedure at Communication Terminal

The processing procedures at communication terminal 100 according to the second embodiment differs from those of the first embodiment shown in FIG. 7 in only in the number of frequency bands of which communication quality is to be monitored (corresponding to step S202). Therefore, detailed description will not be repeated.

### g5: Exemplified Modification

In the case where carrier aggregation is performed using a plurality of SCCs, a notification of performing a PCC/SCC switching process over again may be sent when a determination is made that the communication quality of a frequency band differing from the frequency band specified by HeNB base station 200 is more favorable as a result of communication terminal 100 comparing the communication quality in response to a PCC/SCC switching preparation request from HeNB base station 200. In this case, communication terminal 100 may notify HeNB base station 200 of a reprocessing request or a NACK signal. In response to this notification, HeNB base station 200 performs over again the frequency band communication quality comparison, and tries again a PCC/SCC switching process.

Although the above description is based on an example of adding frequency band information to the switching preparation request from HeNB base station 200, a number or sign to identify a SCC subject of a PCC/SCC switching process may be determined in advance, and specify a frequency band corresponding to the SCC using the determined number or sign, in addition to or alternative to the frequency band information.

For example, when a plurality of component carriers are used at HeNB base station 200, the numbers of “1”, “2” and “3” are assigned in advance to the frequency band used as the PCC, the frequency band used as SCC1, and the frequency band used as SCC2, respectively, and a notification of the number of “2” or “3” is sent when modifying the frequency band to be used as the PCC, instead of the frequency band information. Alternatively, a method of notifying a number assigned to each frequency band may be employed.

### g6: Advantage

According to wireless communication system SYS of the present embodiment, PCC/SCC switching can be performed by simplified procedures during communication between HeNB base station 200 and communication terminal 100 using carrier aggregation.

Specifically, according to wireless communication system SYS of the present embodiment, a notification to MME 400 and the like is not required in executing PCC/SCC switching since the Cell_ID does not have to be modified. In other words, only the process between HeNB base station 200 and communication terminal 100 is required. Accordingly, the core network processing load can be alleviated.

The event of spontaneous degradation in the user data throughput such as when a handover process is used, can be avoided. Accordingly, the average throughput can be improved. Moreover, complicated processing such as RACH processing is not required.

In carrier aggregation, the PCC includes a control signal that monitors the communication service. Therefore, there is generally the tendency of the PCC frequency usage becoming higher. From the standpoint of HeNB base station 200, increase of communication terminals 100 utilizing a certain frequency band as the PCC causes a higher usage efficiency of that frequency band, resulting in increase of the signal processing load on that certain frequency band. By switching the frequency used as the PCC with the frequency band used as the SCC taking advantage of the PCC/SCC switching as in the present embodiment, the signal processing load on a certain frequency band can be alleviated. In other words, since the PUCCH is handled only through the PCC, a SCC that does not handle the PUCCH has more room for resource allocation than the PCC. As such, the frequency band usage efficiency can be distributed.

### H: THIRD EMBODIMENT

### h1: General

The first and second embodiments have been described based on a method of sending a notification of a PCC/SCC switching preparation request from HeNB base station 200 to a communication terminal 100 communicating with HeNB base station 200 through individual control signals. The third embodiment is based on the case of notifying all communication terminals 100 located in the service area of HeNB base station 200 of a PCC/SCC switching preparation request by common broadcast information. In other words, the third embodiment is based on a method of executing PCC/SCC switching together at one time for communication terminals 100 communicating with HeNB base station 200. This method is a one-time switching method by broadcast information.

### h2: Overall Procedure

The overall processing of PCC/SCC switching at a wireless communication system SYS according to the third embodiment will be described hereinafter.

In the third embodiment, a PCC/SCC switching preparation request is notified from HeNB base station 200 using broadcast information. Although the usage of broadcast information will cause a PCC/SCC switching preparation request to be sent together at one time to all communication terminals 100 connected to HeNB base station 200, a communication terminal 100 communicating with HeNB base station 200 not utilizing carrier aggregation will ignore this broadcast information. Therefore, only a communication terminal 100 communicating with HeNB base station 200 utilizing carrier aggregation will execute PCC/SCC switching.

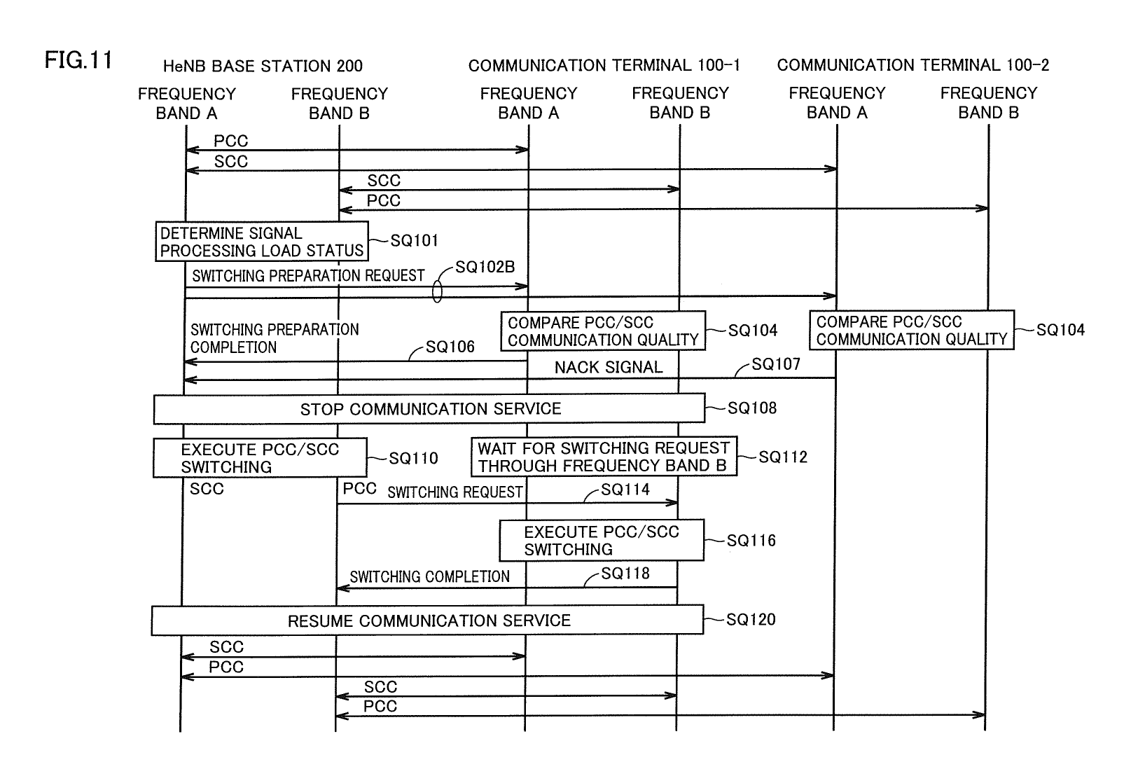

FIG. 11 is a sequence chart representing the overall processing of PCC/SCC switching at wireless communication system SYS according to the third embodiment. For the sake of convenience, FIG. 11 corresponds to the case where two communication terminals 100-1 and 100-2 communicate with HeNB base station 200 utilizing carrier aggregation. In other words, a plurality of communication terminals 100-1 and 100-2 are connected to HeNB base station 200.

As the initial state, it is assumed that communication with HeNB base station 200 is performed by communication terminal 100-1 using frequency band A as the PCC and frequency band B as the SCC, and communication terminal 100-2 using frequency band A as the SCC and frequency band B as the PCC. It is to be noted that HeNB base station 200 may perform communication with more communication terminals 100 utilizing carrier aggregation.

During communication with communication terminals 100-1 and 100-2, communication controller 212 of HeNB base station 200 determines the status of the signal processing load on each frequency band (sequence SQ101). For example, in the case where HeNB base station 200 is communicating with a plurality of communication terminals 100, and the frequency usage of frequency band A is high to cause an increase in the signal processing load on frequency band A while the frequency usage of frequency band B is still low such that there is room for the signal processing load on frequency band B, a PCC/SCC switching preparation request is sent together at one time to all communication terminals 100 located in the service area of HeNB base station 200 (sequence SQ102B). For this one time notification of a PCC/SCC switching preparation request, broadcast information is used.

When the notification means (data processor 204, communication controller 212 and level comparator 214) provided at HeNB base station 200 detects a state in which the frequency band used as the main frequency band (PCC) among the plurality of frequency bands is to be switched, a switching preparation request is sent at one time together towards communication terminals 100 connected to HeNB base station 200.

Among the communication terminals located in the service area of HeNB base station 200 and receiving communication service, communication terminal 100-1 using frequency band A as the PCC and frequency band B as the SCC at that point in time compares the communication quality between frequency band A and frequency band B upon receiving a PCC/SCC switching preparation request (step S104). When a determination is made that switching between frequency band A used as the PCC and frequency band B used as the SCC leads to improving the communication throughput, communication terminal 100-1 sends a notification to HeNB base station 200 of PCC/SCC switching preparation completion (sequence SQ106).

In other words, the determination means (data processor 104, communication controller 112 and level comparator 114) provided at communication terminal 100-1 responds to the switching preparation request to determine whether in a state in which the frequency band used as the main frequency band (PCC) is to be switched. Then, the notification means (communication controller 112) provided at communication terminal 100-1 notifies HeNB base station 200 of frequency band switching preparation completion in response to a determination of being in a state in which the frequency band used as the main frequency band (PCC) is to be switched.

In contrast, communication terminal 100-2 already performing carrier aggregation under a state where PCC/SCC switching has been designated sends a NACK signal to HeNB base station 200 (sequence SQ107). Alternatively, communication terminal 100-2 determining that the communication throughput will not be improved even if frequency band A used as the PCC is switched with frequency band B used as the SCC sends a NACK signal to HeNB base station 200.

In other words, the determination means (data processor 104, communication controller 112 and level comparator 114) provided at communication terminal 100-2 notifies HeNB base station 200 that a frequency switching process will not be performed if the frequency band is not a subject of the switching preparation request.

HeNB base station 200 executes PCC/SCC switching for only a communication terminal 100-1 from which switching preparation completion was returned. In other words, PCC/SCC switching is not executed for a communication terminal 100-1 returning a NACK signal.

The PCC/SCC switching process is similar to that of the first embodiment set forth above. Therefore, detailed description will not be repeated.

By switching some of communication terminals 100 that was using frequency band A as the PCC (communication terminal 100-1) to use frequency band B as the PCC, the usage of frequency band A can be distributed.

### h3: Processing Procedure at HeNB Base Station

The processing procedures at HeNB base station 200 according to the third embodiment differ only in the process of determining the signal processing load state (corresponding to steps S100 and S102), and the method of notifying a PCC/SCC switching preparation request (corresponding to step S104), as compared to the processing procedures according to the first embodiment shown in FIG. 6. Therefore, detailed description will not be repeated.

### h4: Processing Procedure at Communication Terminal

The processing procedures at communication terminal 100 according to the third embodiment are substantially similar to those of the first embodiment shown in FIG. 7. Therefore, detailed description thereof will not be repeated.

### h5: Advantage

According to wireless communication system SYS of the present embodiment, PCC/SCC switching can be performed by simplified procedures when HeNB base station 200 and communication terminal 100 are communicating using carrier aggregation.

More specifically, since the Cell_ID does not have to be modified in wireless communication system SYS according to the present embodiment, notification towards MME 400 and the like is not required in the execution of PCC/SCC switching. In other words, only the processing between HeNB base station 200 and communication terminal 100 is required. Accordingly, the processing load on the core network can be reduced.

Moreover, the event of spontaneous degradation of the user data throughput, such as in the case where a handover process is used, can be avoided. Therefore, the average throughput can be improved. Complicated processing such as RACH processing is also not required.

In carrier aggregation, the PCC includes a control signal that monitors the communication service. Therefore, there is generally the tendency of the PCC frequency usage becoming higher. From the standpoint of HeNB base station 200, increase of communication terminals 100 utilizing a certain frequency band as the PCC causes a higher usage efficiency of that frequency band, resulting in increase of the signal processing load on that certain frequency band. By switching the frequency band used as the PCC with the frequency band used as the SCC taking advantage of the PCC/SCC switching as in the present embodiment, the signal processing load on a certain frequency band can be alleviated. In other words, since the PUCCH is handled only through the PCC, a SCC that does not handle the PUCCH has more room for resource allocation than the PCC. As such, the frequency band usage efficiency can be distributed.

Wireless communication system SYS according to the present embodiment employs a one-time switching scheme through broadcast information. Therefore, the PCC/SCC switching process can be executed together in the case where there are few communication terminals 100 connected to HeNB base station 200. Therefore, the signal processing load on HeNB base station 200 is low, and the time required for the PCC/SCC switching process can be shortened.

### I: FOURTH EMBODIMENT

### i1: General

The fourth embodiment will be described based on PCC/SCC switching corresponding to the type of communication service HeNB base station 200 provides. This scheme is an individual switching scheme of a communication terminal based on the service type.

According to the current specification, the type of services provided by HeNB base station 200 includes the three types of a CSG (Closed Subscriber Group) cell, OPEN cell, and Hybrid cell. A CSG cell is permitted of connection with a restricted specified communication terminal. An OPEN cell is permitted of connection with many unspecified communication terminals. A hybrid cell has the characteristics of both an OPEN cell and CSG cell, allowing connection of both CSG and OPEN on a moment-to-moment basis.

Since an OPEN cell generally has a high frequency usage since many unspecified communication terminals can be connected, the resource allocation available for one communication terminal becomes smaller. In contrast, a CSG cell can increase more readily the resource available for one communication terminal since only restricted specific communication terminals are connected.

For example, consider the case where the component carrier used as the PCC is an OPEN cell or Hybrid cell, and the component carrier used as a SCC is a CSG cell. Since a component carrier presented as an OPEN cell or Hybrid cell is used as the PCC, many more resources will be taken as compared to the case where the component carrier is used as the SCC. In contrast, it is more preferable to allow a component carrier presented as an OPEN cell or Hybrid cell to be connected to many more unspecific communication terminals. Therefore, the resource is to be made available preferably as much as possible by switching between the PCC and SCC.

In the fourth embodiment, PCC/SCC switching is executed on a communication terminal 100 that is using the component carrier provided as an OPEN cell or Hybrid cell by HeNB base station 200 as the PCC. In other words, a service type is defined for each of the plurality of frequency bands in the fourth embodiment.

In this case, following execution of PCC/SCC switching, a notification must be sent to only a communication terminal that can have the subject component carrier used as the PCC. HeNB base station 200 will initiate PCC/SCC switching upon confirming the CSG_ID owned by communication terminal 100.

In other words, a PCC/SCC switching preparation request is sent to only a communication terminal 100 that can used a CSG cell in the fourth embodiment. Following execution of PCC/SCC switching, the component carrier that is used as the PCC is a CSG cell, whereas the component carrier used as a SCC is an OPEN cell or Hybrid cell.

### i2: Overall Procedure

The overall processing of PCC/SCC switching at wireless communication system SYS according to the fourth embodiment will be described hereinafter.

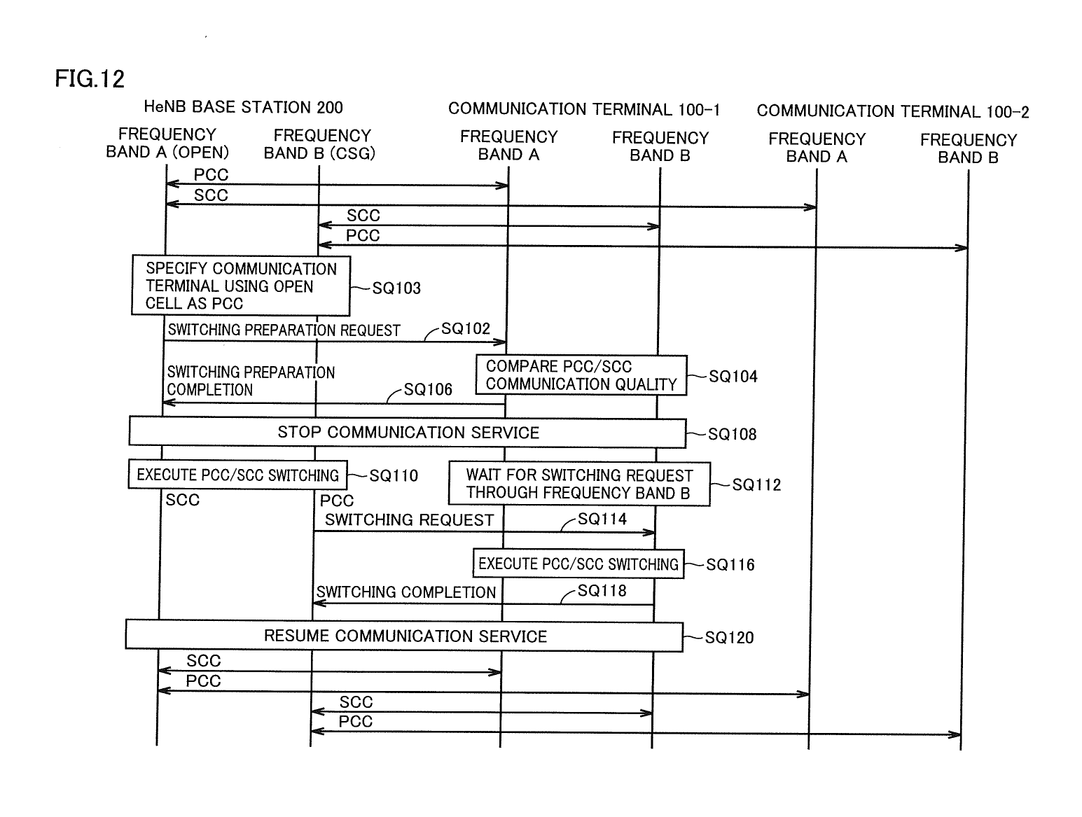

FIG. 12 is a sequence chart representing the overall processing of PCC/SCC switching at wireless communication system SYS according to the fourth embodiment. For the sake of convenience, FIG. 12 corresponds to the case where the component carriers of frequency band A and frequency band B provided by HeNB base station 200 are an OPEN cell and CSG cell, respectively. As the initial state, it is assumed that communication with HeNB base station 200 is performed by communication terminal 100-1 using frequency band A as the PCC and frequency band B as the SCC, and communication terminal 100-2 using frequency band A as the SCC and frequency band B as the PCC. HeNB base station 200 may be communicating with more communication terminals 100 using carrier aggregation.

During communication with communication terminals 100-1 and 100-2, communication controller 212 of HeNB base station 200 specifies the communication terminal using an OPEN cell as the PCC (sequence SQ103). In the example shown in FIG. 12, HeNB base station 200 sends a PCC/SCC switching preparation request towards communication terminal 100-1 utilizing frequency band A as the PCC upon confirming that communication terminal 100-1 is using frequency band A that is an OPEN cell as the PCC and frequency band B that is a CSG cell as a SCC (sequence SQ102). The PCC/SCC switching preparation request is transmitted through frequency band A used as the PCC. This is for the purpose of making the resource of frequency band A providing an OPEN cell available to allow many unspecified communication terminals to be connected.

Specifically, the notification means (data processor 204, communication controller 212 and level comparator 214) provided at HeNB base station 200 notifies communication terminal 100-1 of a switching preparation request when a state is detected in which the frequency band used as the main frequency band (PCC) among the plurality of frequency bands is to be switched. At this stage, the notification means provided at HeNB base station 200 determines whether in a state in which the frequency band used as the main frequency band is to be switched, based on the service type of the frequency band used as the main frequency band (PCC).

Communication terminal 100-1 using frequency band A as the PCC and frequency band B as a SCC to date, among the communication terminals located in the service area of HeNB base station 200 receiving communication service, compares the communication quality between frequency band A and frequency band B upon receiving a PCC/SCC switching preparation request. When a determination is made that the PCC and SCC are to be switched as a result of comparing the communication quality between frequency band A and frequency band B, communication terminal 100-1 notifies HeNB base station 200 of PCC/SCC switching preparation completion (sequence SQ106).

HeNB base station 200 executes PCC/SCC switching only on communication terminal 100-1 returning switching preparation completion. Since this PCC/SCC switching process is similar to that of the first embodiment set forth above, detailed description will not be repeated.

HeNB base station 200 does not send a PCC/SCC switching preparation request to a communication terminal 100-2 that is using frequency band A as the SCC and frequency band B as the PCC.

At sequence SQ103 of FIG. 12, HeNB base station 200 verifies the service type of communication terminal 100, and sends a PCC/SCC switching preparation request only to a communication terminal 100-1 determined that switching between the PCC and SCC is allowed.

Specifically, HeNB base station 200 in the fourth embodiment sets the priority of each service provided, and switches the PCC and SCC according to the priority. As the basic principle, the PCC and SCC are switched such that a frequency band provided as a CSG cell is preferably used as the PCC whereas a frequency band provided as an OPEN cell is preferably used as a SCC.

In the case where frequency band A and frequency band B are of the same service type, the communication quality may be compared, as described in the first embodiment, to determine whether PCC/SCC switching is required or not.

### i3: Processing Procedure at HeNB Base Station

The processing procedures at HeNB base station 200 according to the fourth embodiment differ only in the process of identifying a communication terminal using an OPEN cell as the PCC (corresponding to steps S100 and S102), as compared to the processing procedures according to the first embodiment shown in FIG. 6. Therefore, detailed description thereof will not be repeated.

### i4: Processing Procedure at Communication Terminal

The processing procedures at communication terminal 100 according to the fourth embodiment are substantially similar to those of the first embodiment shown in FIG. 7. Therefore, detailed description thereof will not be repeated.

### i5: Advantage

According to wireless communication system SYS of the present embodiment, PCC/SCC switching can be performed by simplified procedures when HeNB base station 200 and communication terminal 100 are communicating using carrier aggregation.

More specifically, since the Cell_ID does not have to be modified in wireless communication system SYS according to the present embodiment, notification towards MME 400 and the like is not required in the execution of PCC/SCC switching. In other words, only the processing between HeNB base station 200 and communication terminal 100 is required. Accordingly, the processing load on the core network can be reduced.

Moreover, the event of spontaneous degradation of the user data throughput, such as in the case where a handover process is used, can be avoided. Therefore, the average throughput can be improved. Complicated processing such as RACH processing is also not required.

In carrier aggregation, the PCC includes a control signal that monitors the communication service. Therefore, there is generally the tendency of the PCC frequency usage becoming higher. From the standpoint of HeNB base station 200, increase of communication terminals 100 utilizing a certain frequency band as the PCC causes a higher usage efficiency of that frequency band, resulting in increase of the signal processing load on that certain frequency band. By switching the frequency used as the PCC with the frequency band used as the SCC taking advantage of the PCC/SCC switching as in the present embodiment, the signal processing load on a certain frequency band can be alleviated. In other words, since the PUCCH is handled only through the PCC, a SCC that does not handle the PUCCH has more room for resource allocation than the PCC. As such, the frequency band usage efficiency can be distributed.

Wireless communication system SYS according to the present embodiment employs an individual switching scheme of a communication terminal based on the service type. By employing the present scheme, the component carrier available as a CSG cell can be used exclusively as the PCC. Moreover, since the usage of the resource of the component carrier available as an OPEN cell or Hybrid cell can be reduced, more communication terminals 100 can be connected to HeNB base station 200.

### J: FIFTH EMBODIMENT

### j1: General

The first to fourth embodiments have been described based on a processing example in which HeNB base station 200 governs execution of PCC/SCC switching. Alternatively, communication terminal 100 may govern execution of PCC/SCC switching. The fifth embodiment will be described based on an example in which PCC/SCC switching is executed, governed by communication terminal 100. In other words, the scheme according to the fifth embodiment is a switching scheme governed by communication terminal 100.

More specifically, as the means for communication terminal 100 to switch between the PCC and SCC, a PCC/SCC switching preparation request is transmitted from communication terminal 100 to HeNB base station 200. In response to this PCC/SCC switching preparation request, HeNB base station 200 initiates PCC/SCC switching.

### j2: Overall Procedure

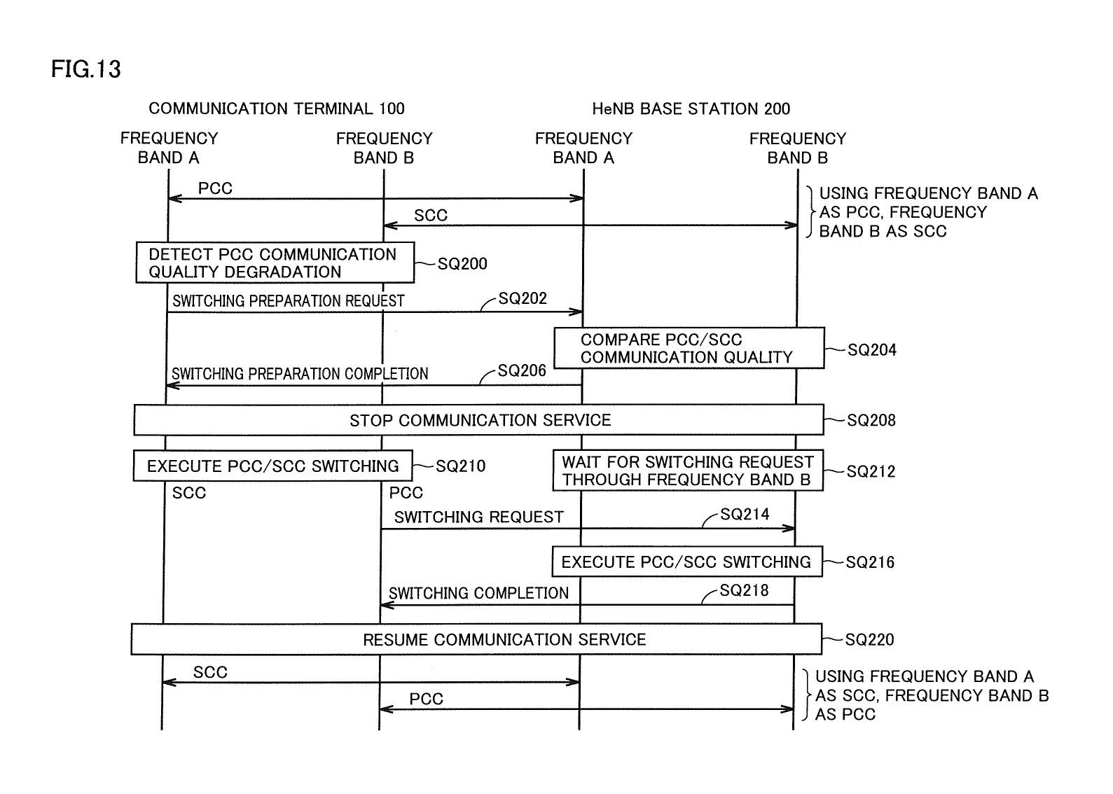

The overall processing of PCC/SCC switching at wireless communication system SYS according to the fifth embodiment will be described hereinafter. FIG. 13 is a sequence chart representing the overall processing of PCC/SCC switching at wireless communication system SYS according to the fifth embodiment. The sequence chart of FIG. 13 is substantially a replacement of the functions between HeNB base station 200 and communication terminal 100 in the sequence chart of FIG. 5.

Referring to FIG. 13, it is assumed that HeNB base station 200 is communicating with communication terminal 10 using frequency band A as the PCC and frequency band B as the SCC, as the initial state.

During communication with HeNB base station 200, level comparator 114 of communication terminal 100 monitors the communication quality of frequency bands A and B. In other words, level comparator 114 of communication terminal 100 compares the communication quality between the PCC and SCC (sequence SQ200).

When level comparator 114 of communication terminal 100 determines that the communication quality of frequency band A used as the PCC is lower than the communication quality of frequency band B used as a SCC, and that switching the frequency band used as the PCC will lead to improvement in communication throughput, HeNB base station 200 is notified of a PCC/SCC switching preparation request (sequence SQ202). The PCC/SCC switching preparation request is transmitted through frequency band A used as the PCC.

In addition to detecting that the communication quality of the frequency band used as the PCC is degraded, occurrence of a delayed state of PUCCH response (that is, when a determination is made that the resource allocation of PUCCH used by communication terminal 100 is insufficient) may be detected to send a PCC/SCC switching preparation request from communication terminal 100 to HeNB base station 200.

In other words, the notification means (data processor 104, communication controller 112 and level comparator 114) provided at communication terminal 100 notifies HeNB base station 200 of a switching preparation request upon detecting a state in which the frequency band used as the main frequency band (PCC) among the plurality of frequency bands is to be switched.

Upon receiving a PCC/SCC switching preparation request from communication terminal 100, level comparator 214 of HeNB base station 200 compares the communication quality between the PCC and SCC (sequence SQ204). When a determination is made that the communication quality of frequency band A used as the PCC is degraded and the communication quality of frequency band B used as a SCC is better as a result of level comparator 214 of HeNB base station 200 comparing the communication quality between the PCC and SCC, HeNB base station 200 sends a notification of PCC/SCC switching preparation completion to communication terminal 100 (sequence SQ206).

In other words, the determination means (data processor 204, communication controller 212 and level comparator 214) provided at HeNB base station 200 responds to a switching preparation request to determine whether in a state in which the frequency band used as the main frequency band (PCC) is to be switched. Then, the notification means (communication controller 212) provided at HeNB base station 200 notifies communication terminal 100 of completing frequency band switching preparation in response to a determination of being in a state in which the frequency band used as the main frequency band (PCC) is to be switched.

Following notification of PCC/SCC switching preparation completion, HeNB base station 200 temporarily stops the communication service (sequence SQ208), and waits for a PCC/SCC switching request from communication terminal 100 through frequency band B used as a SCC (sequence SQ212).

Thereafter, sequences SQ214-SQ218 similar to sequences SQ114-SQ118 of FIG. 5 are executed. Communication terminal 100 and HeNB base station 200 resume the communication service by using frequency band B as the PCC and frequency band A as the SCC (sequence SQ220).

Thus, wireless communication system SYS has the function of initiating a switching process of the frequency band used as the main frequency band (PCC) between HeNB base station 200 and communication terminal 100 in response to PCC/SCC switching preparation completion.

The overall processing of FIG. 13 may be modified as set forth below.

Information to specify a component carrier used as the PCC after PCC/SCC switching can be added to the PCC/SCC switching preparation request sent from communication terminal 100 to HeNB base station 200. In this case, HeNB base station 200 determines whether PCC/SCC switching is required or not individually in response to a PCC/SCC switching request from communication terminal 100.

As described in the first embodiment, each message transferred between communication terminal 100 and HeNB base station 200 may be sent, not only through the frequency band used as the PCC, but also through both the frequency bands used as the PPC and SCC. For example, a notification of a PCC/SCC switching preparation request from communication terminal 100 to HeNB base station 200 may be sent through the two frequency bands of frequency band A and frequency band B.

Moreover, the usage of two frequency bands may include the mode of transmitting independently the same two messages through respective frequency bands, or transmitting one message through two frequency bands. In the case of the latter, the method employed may divide one message at the transmission side and send the divided messages through the two allocated frequency bands, and then combine the data received through each of the two frequency bands at the reception side to constitute one message.

### j3: Processing Procedure at Communication Terminal and HeNB Base Station

The processing procedures at communication terminal 100 and HeNB base station 200 according to the fifth embodiment are equal to the processing procedures at HeNB base station 200 and communication terminal 100 shown in FIGS. 6 and 7, exchanged with each other. Therefore, detailed description will not be repeated.

### j4: Advantage

According to wireless communication system SYS of the present embodiment, PCC/SCC switching can be performed by simplified procedures when HeNB base station 200 and communication terminal 100 are communicating utilizing carrier aggregation.

Specifically, since the Cell_ID does not have to be modified in wireless communication system SYS according to the present embodiment, notification towards MME 400 and the like is not required in the execution of PCC/SCC switching. In other words, only the processing between HeNB base station 200 and communication terminal 100 is required. Accordingly, the processing load on the core network can be reduced.

Moreover, the event of spontaneous degradation of the user data throughput, such as in the case where a handover process is used, can be avoided. Therefore, the average throughput can be improved. Complicated processing such as RACH processing is also not required.

In carrier aggregation, the PCC includes a control signal that monitors the communication service. Therefore, there is generally the tendency of the PCC frequency usage becoming higher. From the standpoint of HeNB base station 200, increase of communication terminals 100 utilizing a certain frequency band as the PCC causes a higher usage efficiency of that frequency band, resulting in increase of the signal processing load on that certain frequency band. By switching the frequency used as the PCC with the frequency band used as the SCC taking advantage of the PCC/SCC switching as in the present embodiment, the signal processing load on a certain frequency band can be alleviated. In other words, since the PUCCH is handled only through the PCC, a SCC that does not handle the PUCCH has more room for resource allocation than the PCC. As such, the frequency band usage efficiency can be distributed.

Wireless communication system SYS according to the present embodiment employs an individual switching scheme governed by communication terminal 100. Since communication terminal 100 does not have to wait for a PCC/SCC switching preparation request from HeNB base station 200 in this scheme, PCC/SCC switching can be initiated immediately even in the case where the wireless environment is suddenly degraded. Moreover, since each communication terminal 100 determines whether PCC/SCC switching is required or not, the state of each communication terminal does not have to be identified all the time, allowing the process load on HeNB base station 200 to be alleviated.

### K: OTHER EMBODIMENTS

The configuration shown in the first to fifth embodiments set forth above can be combined appropriately.

Although the first to fifth embodiments have been described mainly focusing on component carrier switching during communication with a communication terminal using carrier aggregation with a home evolved node (HeNB base station), the base station to which the present invention can be applied is not limited to a HeNB base station. The present invention also can be applied to a general evolved node B (eNB base station) providing a macrocell or a base station of other types.

Moreover, the first to fifth embodiments set forth above are examples applied to, but not limited to a LTE-A scheme. The embodiments may be applied to an arbitrary scheme.

### L. CONCLUSION

Respective embodiments of the present invention set forth above are suitable to the event set forth below for each of the embodiments.

In the case where communication is performed with a plurality of communication terminals 100 connected to HeNB base station 200, the communication terminal individual switching scheme based on resource allocation (exemplified modification of first embodiment), and the communication terminal individual switching based on the service type (fourth embodiment) are preferable. Accordingly, the component carrier used by each communication terminal 100 can be distributed more readily.

In the case where communication is carried out with few communication terminals 100 connected to HeNB base station 200, the communication terminal individual switching scheme based on the wireless environment condition (first and second embodiments), the scheme of executing PCC/SCC switching together at one time (third embodiment), and/or the switching scheme governed by a communication terminal (fifth embodiment) are preferably employed. Accordingly, flexible correspondence can be performed individually according to the communication status and wireless environment.

It is to be understood that the embodiments disclosed herein are only by way of example, and not to be taken by way of limitation. The scope of the present invention is not limited by the description above, but rather by the terms of the appended claims, and is intended to include any modifications within the scope and meaning equivalent to the terms of the claims.

### REFERENCE SIGNS LIST

100 communication terminal; 104, 204 data processor; 106, 116, 206, 216 encoding processor; 108, 118, 208, 218 antenna transmission/reception unit; 110, 120, 210, 220 antenna; 112, 212 communication controller; 114, 214 level comparator; 130 display; 132 microphone; 134 speaker; 136 input unit; 200 HeNB base station; 201, 301 service area; 202 network interface; 300 eNB base station; 400 MME, SYS wireless communication system.

1-14. (canceled)

15. A wireless communication system comprising a base station and a communication terminal that can communicate with the base station through a plurality of frequency bands, the plurality of frequency bands including a main frequency band and at least one sub frequency band, the wireless communication system comprising:
a first notification module, provided at the base station, configured to notify the communication terminal of a switching preparation request when a state is detected in which a frequency band used as the main frequency band among the plurality of frequency bands is to be switched,
a determination module, provided at the communication terminal, configured to determine, in response to the switching preparation request, whether in a state in which the frequency band used as the main frequency band is to be switched,
a second notification module configured to notify the communication terminal of frequency band switching preparation completion in response to a determination of being in a state in which the frequency band used as the main frequency band is to be switched, and
a switching module configured to initiate, in response to the switching preparation completion, a switching process of the frequency band used as the main frequency band between the base station and the communication terminal,
the first notification module being configured to notify together at one time a plurality of the communication terminals connected to the base station of the switching preparation request,
the determination module being configured to notify that a frequency band switching process is not performed if not a subject of the switching preparation request.

16. The wireless communication system according to claim 15, wherein the first notification module is configured to determine a communication quality of the frequency band used as the main frequency band.

17. The wireless communication system according to claim 15, wherein the first notification module is configured to determine whether a resource for the frequency band used as the main frequency band is insufficient or not.

18. A wireless communication system comprising a base station, and a communication terminal that can communicate with the base station through a plurality of frequency bands, the plurality of frequency bands including a main frequency band and at least one sub frequency band, the wireless communication system comprising:
a first notification module, provided at one of the base station and the communication terminal, configured to notify the other of the base station and the communication terminal of a switching preparation request when a state is detected in which a frequency band used as the main frequency band among the plurality of frequency bands is to be switched,
a determination module, provided at the other of the base station and communication terminal, configured to determine, in response to the switching preparation request, whether in a state in which the frequency band used as the main frequency band is to be switched,
a second notification module configured to notify one of the base station and communication terminal of frequency band switching preparation completion in response to a determination of being in a state in which the frequency band used as the main frequency band is to be switched, and
a switching module configured to initiate, in response to the switching preparation completion, a switching process of the frequency band used as the main frequency band between the base station and the communication terminal,
the plurality of frequency bands each having a service type provided by the base station defined, and a range of a communication terminal permitted of connection being specified for each service type,
the first notification module being configured to determine whether in a state in which the frequency band used as the main frequency band is to be switched, based on the service type of the frequency band used as the main frequency band.

19. The wireless communication system according to claim 15, wherein
the plurality of frequency bands include a plurality of the sub frequency bands, and
the first notification module is configured to notify the switching preparation request including information indicating a sub frequency band that is a subject of switching.

20. The wireless communication system according to claim 18, wherein the first notification module is configured to determine a communication quality of the frequency band used as the main frequency band.

21. The wireless communication system according to claim 18, wherein the first notification module is configured to determine whether a resource for the frequency band used as the main frequency band is insufficient or not.

22. The wireless communication system according to claim 15, wherein
the first notification module is provided at the communication terminal, and
the determination module and the second notification module are provided at the base station.

23. The wireless communication system according to claim 15, wherein the switching module is configured to notify, after completing switching of the frequency band at the one of the base station and communication terminal, the other of the base station and communication terminal of a switching request instructing switching of the frequency band through the frequency band used as a new main frequency band.

24. A communication method between a base station and a communication terminal that can communicate with the base station through a plurality of frequency bands, the plurality of frequency bands including a main frequency band and at least one sub frequency band, the method comprising the steps of:
notifying, when a state is detected in which a frequency band used as the main frequency band among the plurality of frequency bands is to be switched at the base station, the communication terminal of a switching preparation request,
determining, in response to the switching preparation request at the communication terminal, whether in a state in which the frequency band used as the main frequency band is to be switched,
notifying the base station of frequency switching preparation completion in response to a determination of being in a state in which the frequency band used as the main frequency band is to be switched, and
initiating, in response to the switching preparation completion, a switching process of the frequency band used as the main frequency band between the base station and the communication terminal,
the step of notifying a switching preparation request including the step of notifying together at one time a plurality of the communication terminals connected to the base station of the switching preparation request,
the step of determining including the step of notifying that a frequency band switching process is not performed if not a subject of the switching preparation request.

25. A base station that can communicate with a communication terminal through a plurality of frequency bands, the plurality of frequency bands including a main frequency band and at least one sub frequency band, the base station comprising:
a notification module configured to notify the communication terminal of a switching preparation request when a state is detected in which a frequency band used as the main frequency band among the plurality of frequency bands is to be switched, and
a switching module configured to initiate a switching process of the frequency band used as the main frequency band between the base station and the communication terminal in response to frequency band switching preparation completion from the communication terminal,
the plurality of frequency bands each having a service type provided by the base station defined, and a range of a communication terminal permitted of connection being specified for each service type,
the notification module being configured to determine whether in a state in which the frequency band used as the main frequency band is to be switched, based on the service type of the frequency band used as the main frequency band.

26. A communication terminal that can communicate with a base station through a plurality of frequency bands, the plurality of frequency bands including a main frequency band and at least one sub frequency band, the communication terminal comprising:
a notification module configured to notify the base station of a switching preparation request when a state is detected in which a frequency band used as the main frequency band among the plurality of frequency bands is to be switched, and
a switching module configured to initiate, in response to frequency band switching preparation completion from the base station, a switching process of the frequency band used as the main frequency band between the base station and the communication terminal,
the plurality of frequency bands each having a service type provided by the base station defined, and a range of a communication terminal permitted of connection being specified for each service type,
the notification module being configured to determine whether in a state in which the frequency band used as the main frequency band is to be switched, based on the service type of the frequency band used as the main frequency band.

27. A communication method between a base station and a communication terminal that can communicate with the base station through a plurality of frequency bands, the plurality of frequency bands including a main frequency band and at least one sub frequency band, the method comprising the steps of:
notifying, when a state is detected in which a frequency band used as the main frequency band among the plurality of frequency bands is to be switched at one of the base station and communication terminal, the other of the base station and communication terminal of a switching preparation request,
determining, in response to the switching preparation request at the other of the base station and communication terminal, whether in a state in which the frequency band used as the main frequency band is to be switched,
notifying the one of the base station and communication terminal of frequency switching preparation completion in response to a determination of being in a state in which the frequency band used as the main frequency band is to be switched, and
initiating, in response to the switching preparation completion, a switching process of the frequency band used as the main frequency band between the base station and the communication terminal,
the plurality of frequency bands each having a service type provided by the base station defined, and a range of a communication terminal permitted of connection being specified for each service type,
the step of notifying a switching preparation request including the step of determining whether in a state in which the frequency band used as the main frequency band is to be switched, based on the service type of the frequency band used as the main frequency band.

28. The wireless communication system according to claim 18, wherein
the plurality of frequency bands include a plurality of the sub frequency bands, and
the first notification module is configured to notify the switching preparation request including information indicating a sub frequency band that is a subject of switching.

29. The wireless communication system according to claim 18, wherein
the first notification module is provided at the communication terminal, and
the determination module and the second notification module are provided at the base station.

30. The wireless communication system according to claim 18, wherein the switching module is configured to notify, after completing switching of the frequency band at the one of the base station and communication terminal, the other of the base station and communication terminal of a switching request instructing switching of the frequency band through the frequency band used as a new main frequency band.
